(19) United States
(12) Patent Application Publication
(10) Pub. No.: US 2004/0193432 A1
(43) Pub. Date: Sep. 30, 2004

(54) Automated and integrated acquisition system and process

(76) Inventor: Tariq Khalidi, Sacramento, CA (US)

Correspondence Address: BERNHARD KRETEN, ESQ & ASSOCIATES, 1331 GARDEN HIGHWAY, SUITE 300, SACRAMENTO, CA, 95833, US

(21) Appl. No.: 10/397,715

(22) Filed: Mar. 25, 2003

(51) Int. Cl. G06F 17/60

(52) U.S. Cl. 705/1

(57) ABSTRACT

A system and method for optimizing acquisitions simultaneously among more than one project a time. Acquisitions are assembled appropriately as independent or larger packages. Components for acquisitions are broken out of the overall project and combined with like components of other projects. Each component package is then submitted to an appropriate market for the appropriate type of procurement. After procurement, components are reassembled into their original projects and distributed back into the acquisitions. This method allows more sellers to participate in the process and, at the same time, allows buyers to reap the benefit of volume transactions in their dealings with sellers. The integrity of the acquisition is maintained.

### FIELD OF THE INVENTION

The following invention is generally related to instrumentalities and methodologies in implementing economic applications. More specifically, the instant invention is directed to a system and method for utilizing management tools to optimize procurement and sales affecting markets worldwide.

### BACKGROUND OF THE INVENTION

Definitions

This invention is better understood if some words are defined in the context of this invention:

Acquisition Acquisition in its broadest form means the activity of acquiring. This activity includes all of the means, methods, apparatus, procedures and processes before and after the activity of procurement, whereas the activity of procurement further includes all of the means, methods, apparatus, procedures and processes before and after the activity of purchase.

Bundling In the context of acquisition, bundling refers to a collection of several individual procurements as one procurement package. The concept was proposed as a savings measure by the U.S. Federal Government.

Creation and Tracking of Capital

The effective creation, optimized spending, continuous analysis and transparent oversight of Capital

A collection of means, methods, procedures, apparatus etc. that creates capital, optimizes the spending of capital, monitors the movement of capital, analyzes the flow of capital and provides an audit and oversight of capital movement in the production of goods, works and services.

It also measures the effect of capital: when created, used, monitored and audited in an optimized and integrated manner.

Central and/or Centrally In the context of procurement it may mean the following five or more representations. These representations may apply singly or in any combination of one or more application. The representations include but not limited to:

Location: ‘Central’, as in a ‘central location’. The central location may be physical and/or virtual. The reference includes such modifiers as centrally located.

Entity: ‘Central’ as in a ‘central entity’ or as in a ‘central organization’. The central entity may be a specific department of an organization, a specific organization that serves centrally to other entities such as an organization that serves other organizations, etc.

Activity: ‘Central’ as in a ‘central function’ or as in a ‘main function’, the activity around which other functions take place. Other activities depend or are integral to the central activity.

Assignment: ‘Central’ as in the ‘central point’ or as in a ‘core functionality’ for procuring one and/or multiple assignment/s, project/s, purchase-order/s, requisition/s etc. as well as within the assignment/s, project/s, purchase-order/s, requisition/s etc. such as in ‘central procurement for this project’ etc.

Substance procured: ‘Central’ as in ‘central work/s’, ‘central commodity/ies’, ‘central good/s’ and or ‘central service/s’; procured. Such substance may be tangible or intangible.

Component A component is an element within an assignment

Monopsony An act where the buyer becomes so large or powerful as to thwart the seller and/or sellers into an unfair position of dictating and/or receiving the terms and conditions to the benefit of the buyer. Generally it is associated with a single buyer and multiple sellers who depend on that buyer.

Non-Value-added When value is not added by an intermediary. See below for Value-added

Piggy-back Adding to—in the context of ‘taking advantage’, an existing tangible or intangible individual or package of good/s, work/s, commodity/ies or service.

Basket A group of components of an assignment/s, project/s, purchase-order/s, acquisition/s, contract/s etc. These components share some common characteristics. These components are temporarily grouped to accomplish specific purpose/s. The group is generally but not always, undone after the specific purpose/s is completed.

Value Providing Network A network of entities participating as individual/s, organization/s, group/s etc. and represented as buyer/s, seller/s, intermediary/ies, agent/s etc. Also, a network of means, methods, apparatus, process/es, activity/ies comprised of buying, selling, associated acts of and with good/s, work/s, commodity/ies, service/s etc. that provides value in the conduct of business, trade and commerce.

Abbreviated as: value providing network; network of buyers and sellers of goods works and services.

Value-added In the context of procurement this refers to enhancement to good/s, work/s, commodity/ies or service by an intermediate entity (intermediary—person, group or organization) along its transition from a raw-material to a finished delivery to an end-user.

Prior Art

A lot of prior art refers to ‘purchasing’ as ‘procurement’ and ‘procurement’ as ‘acquisition’. It is important to understand the difference. This invention is about acquisition which includes, but is not limited to procurement and/or to purchasing. There is a hierarchy of acquisition, which includes procurement, and procurement, which includes purchasing.

Purchase v/s Procurement

Often these two terms are used interchangeably, however the have distinct and separate meanings and extent of implications.

Purchasing refers to the actual act of buying; the transaction between the buyer and seller. Sometimes the mere act of bringing together a buyer and seller with a mutual understanding to buy/sell is called a purchase.

Procurement refers to a much larger act. It includes the means, methods, apparatus, procedures and processes before and after a purchase. For example, it includes all of processes before the purchase (such as reviewing the justification for a purchase, budgeting for the purchase, funding the purchase etc.); the means, methods, apparatus, procedures and processes during the purchase (such as any counter-offers) and the means, methods, apparatus, procedures and processes after the purchase (such as evaluation of the offer, preparation of the agreement, payment for the purchase etc.).

Procurement vs Acquisition

Often these two terms are used interchangeably; however they have distinct and separate meanings and extent of implications.

Procurement refers to that described above.

Acquisition refers to the act of acquiring. It includes the means methods apparatus procedures and processes before and after procurement. For example it includes all of processes before the procurement (such as the acts, affects and effects of the seller and the sellers' seller etc. who created the good/s, work/s, commodity/ies and/or service/s in whole or in part; that is being acquired), the means methods apparatus procedures and processes during the procurement (such as any planning, budgeting, resourcing from the upstream tiered sellers etc. ) and the means methods apparatus procedures and processes after the procurement (such as follow-up of the purchase through the phase of implementing the purchase through to delivery to the end user, analyzing the financial and social effects of the procurement and subsequent planning incorporating such effects etc.).

General Categories of Prior Art

Prior Art is found in (a) Collection of Buyers (b) Collection of Buyers and a Collection of things to be purchased, (c) Within large organizations as a ‘Procurement Department’, ‘Contracts Department’ or ‘Operations Department’ or (d) Art practiced by individuals or in decentralized departments of a large organization within which one or a few individuals acting as a Buyer, Purchasing Agent, Purchasing Officer, Contracting Officer etc.

(a) Collection of Buyers

This method is very old and has been practiced from ancient times to today—in a not too- different of a form.

As a small collection of buyers it is called ‘Group Buying’, ‘Buying Club’, ‘Membership only Club’. These are prevalent in the consumer market at a retail level. The buying participants who have paid a small fee to be a participant-buyer expect to get better pricing over the course of the membership. The membership club or the organization presumably negotiates better prices from the sellers on behalf of the members in exchange of the buying volume power of the membership. The buyers do pay a lower price, but not so far apart from what a normal negotiation would have produced.

Example: The retail firm ‘Costco’ or ‘Sam's Club’ for durable and non-durable goods or AAA (American Automobile Association) auto club for buying automobiles at better prices for the AAA members.

At a business level, organizations such as the ‘Joint Powers Authority’ are organized as a loose confederation of quasi-governmental business entities such as the local school districts. The school districts ‘channel’ their buying through a common organization. In theory this organization has negotiated better rates for the membership.

(b) Collection of Buyers and Collection of Things to Purchase

This method brings a group that exists or is set-up as a new group generally very large (sometimes called a consortium). It also attempts to gather the things that have to be purchased by the group, individually or as a whole. Their goal is to extract favorable pricing from the sellers in exchange of the privilege of selling to the very large group—members of which may individually purchase, individual things from the seller.

Example:

The three major automobile manufacturers operating in the U.S., General Motors, Ford and Daimler-Chrysler combined their buying of auto parts into a website for a consortium called ‘Covisint’. They requested that all sellers to these manufacturers register and be channeled through this website to sell to the three buyers.

Similarly, ‘B2B’ Exchanges¹ were organized to bring large number of buyers into one website. These websites generally established the first contact between a buyer and a seller and a very basic buy-sell understanding of purchase. ¹ Arthur B. Scully, W Williams A. Woods; B2B Exchanges, ISI Publications, Copyright 1999

At a government level, in the United States, the Federal Government established a system called the Multiple Award Schedule (MAS) and the California State Government established a similar system called the California Multiple Award Schedule (CMAS). To participate, the sellers are pre-qualified both as a business, their offerings and their pricing for the offerings. A best price in the market for each offering is negotiated and locked-in (with no guarantee of sales) for a term (one to three years) by the buyer of the government. During the term of the agreement, a buyer may purchase the pre-negotiated thing from the seller.

(c) Procurement/Purchasing Department, Contracts Department, Operations Department

For large organizations, this department ‘centralizes’ the purchases that are made on behalf of the organization.

This department is generally found in large organizations such as within the Department of General Services for the State Government of California. This department coordinates the purchasing effort of all other State Agencies and Departments as well as purchases for them things that are estimated to be above a certain threshold Example: Above US $250,000.

They establish their own methods of work and sometimes rely on section (b) above.

(d) Buyer, Purchasing Agent, Purchasing Officer, Contracting Officer etc.

This individual or a group of individuals who perform the purchasing functions for small organizations or ‘decentralized large organizations’. They are generally unstructured as a unit. They rely on some guidelines or Operations Manual within the organization. They often rely on techniques described in section (a) above and sometimes on techniques described in (b) above.

Problems with Prior Art

Prior art is experiencing problems that are categorized below. These categories may be individual and/or inter-related. These categories include but are not limited to:

Multiple Pricing by Sellers

The categories described in the section Prior Art—(a), (b), (c) and (d) use techniques that generally browbeat the seller into providing some consideration in the form of lower prices in exchange of the opportunity, but not the guarantee, to sell to a large group of buyers.

Sellers have become jaded, and offer some consideration to appease such groups. However, in reality a seller cannot give the buyer their best offer at a given time, when a true and real procurement is being solicited; if the original price was agreed upon one to three years ago. Sellers do not maintain long-term inventories and cannot forecast long-term for competitive pricing. The buyer however insists that the seller provide their very best pricing at the time of consummating this long-term contract. However the same contract leaves open the opportunity for the buyer to browbeat the seller again to get the ‘best value’ and/or the ‘best price’ at the time of the real procurement.

Thus, sellers maintain a large number of prices based on a number of variables, for the same good/s, work/s, commodity/ies or service/s. The buyer does not get the optimum price at the time of an actual sale in group-buying because the selling price is not optimized to each sale at a specific given time.

In such a transaction both sides leave somewhat dissatisfied. The buyer perceives that they got the advantage of group-buying and seller feels that doing some business is better than no business—even at a loss, just to keep a ‘business relationship’ alive. On occasion though, the seller is well rewarded if the chance market conditions work out to favor the seller at the time of the real procurement.

Market Efficiency

The prior art does not provide an efficient market for individuals or large groups because of the nature of the mechanism involved in negotiating terms and pricing and how it is implemented.

Prior art is unable to use the leverage of group-buying at a unique and specific given time with specific prevailing conditions in the market.

Prior art does not address the components within a single or multiple assignment/s, project/s, purchase-order/s, requisition/s etc. even though they may be unique and furnished by independent sellers.

Speed to Market and Subsequent Processing

Prior art is slow, inefficient and cumbersome. It is also costly because it is labor-intensive. An individual purchase could take up two to three weeks and a central purchase with requests from other departments could take two to three months². ² Conversation with Kathleen Brown and Dennis Mills, employees of the State of California. March 2001 and August 2002.

This is so because these ‘Central Departments’ buy the traditional way, one purchase at a time either individually or from a pool of sellers like that of a MAS or CMAS seller.

Transaction

Prior art does not readily provide a transaction. It often provides a search and find function between a buyer and seller followed by a contact between buyer and seller.

Transaction Integrity

Prior art does not readily provide the management and financial integrity and accuracy of the transactions undergone by the assignment/s, project/s, purchase-order/s, requisition/s etc. If requested, this is a labor-intensive operation.

Oversight

Prior art does not readily provide accountability and is generally opaque by not being readily traceable. Accountability and Traceability or an audit is a labor-intensive operation.

Analytics

Prior art does not readily provide supporting analysis of the transaction. Such analysis is labor-intensive. Prior art does not readily provide an analysis of procurement by public funds that may be fully or partially disclosed to the participant/s as appropriate to each assignment/s, project/s, purchase-order/s, requisition/s etc.

Outreach

Prior art does not readily provide a market for sellers in general or sellers at different tiers or seller of a specialty. Such sellers who are usually small and have limited resources miss out on selling opportunities.

Integration

Prior art does not readily provide a transaction that is integrated with functions that precede and follow the purchasing function.

Productivity

Prior art does not readily provide efficiency in processing the procurement. An act is often repeated, decreasing productivity.

Flexibility

Prior art does not readily provide the flexibility to ‘market’ appropriately. It does a poor job of marketing to an appropriate market for specific assignment/s, project/s, work/s, commodity/ies. This is so because their methods do not lend to optimizing the market within all other criteria for procurement. They generally advertise in the same publications and on their website in the hope that some sellers will respond. Savvy sellers take advantage of the buyers, often leading to an overpayment by the buyer.

Control

Prior art does not readily provide control of the process of an acquisition or a procurement. Such an ability is desired by large public and private organizations such as the Federal Government or large ‘Developmental Banks’, who manage the critical act of decision making on acquiring appropriately with public funds.

Monopsony

Prior art does not readily provide means, methods, apparatus procedures etc. to prevent Monopsony. The consortia or the buyers groups often create an inadvertent violation of antitrust laws. The U.S. Department of Justice is concerned and monitoring the activities of such groups.

Bundling and Decreased Participation of Sellers as an Economic Unit

Bundling refers to collecting several individual contracts, projects, assignments, purchase orders etc. for acquisition being solicited and awarded as one package. The concept was proposed and is practiced as a money-savings measure to cut down on paperwork and create efficiencies at the U.S. Federal Government. However it decreases the number of sellers who respond to a buyer since there are fewer bundles to respond to. It is impractical to implement and reduces opportunities for small sellers to respond to large bundles.

The smaller businesses protest the idea of bundling, because it prevents them to qualify for the size of the contract or they are incapable of processing such an order for a lack of resources.

MAS and CMAS

These systems were perceived many years ago when communications was slow and cumbersome. They were designed for large groups of buyers to take advantage of pre-negotiated terms and prices from sellers. They have outlived their use.

There are generally two parts to the procurement. First, a government agency determines that procurement of all items below a certain threshold will be conducted with pre-qualified sellers in the system. Second, the buyer pays the seller the pre-set price for the item. However the use of such a system by a buyer can back-fire on the buyer since the buyer, by law cannot bypass the contract or pay less or more than the pre-set price. Often the same buyer can get a better price and service from soliciting outside the MAS or CMAS contract. The very advantage received from group buying is defeated. But in theory, this is a good purchase for buyer since much time was saved by approaching a seller from within the system.

By default, negotiated prices from the seller are not the best—because at the time of negotiation, the seller has no guarantee of a sale or the ability to take a price risk that will be locked for one to three years. The seller hedges these risks by agreeing to a higher price than what the sale would demand in the presence of a real procurement offer in an open and competitive market.

Fair Trade³

Prior art does not readily provide or facilitates in bringing the producer closer to the end-user with fewer intermediaries, to conduct a transaction in business, trade and commerce. This causes an unfair accumulation of intermediary-cost to the substance for sale. As a result the real producer of the substance receives a smaller portion of the end-user's payment. ³ David Ransom, the No-Nonsense guide to Fair Trade. Copyright 2001 New Internationalist Publications Ltd. London

Unavailability of a Mechanism to Concurrently Derive the Benefits of Contract Bundling (based on US laws) and Unbundling of Contracts(based on the US President's Request) and the Inability of the Government to Create Such a Mechanism

Over the past several years many laws and regulations have been enacted in the United States to reform procurement, so that it is streamlined and efficient. In addition the US government is facing a reduction of workforce. Several of these forces combined to have an effect such that the government began to bundle contracts for acquisition. Such bundling is merely the packaging of several small contracts into a single large contract. Contract Bundling created some efficiency in costs and reduction of paperwork, which are some of the goals of the government. However such contract bundling also ‘back-fired’ in that it severely curtailed and/or defeated the concurrent achievement of the socioeconomic goals which are equally important in the public sector.

On Mar. 19, 2002, the President of the United States called upon the Office of Management and Budget (OMB) to prepare a strategy for unbundling contracts⁴. ⁴ Small Business Agenda, Mar. 19, 2002

The Office of Federal Procurement Policy (OFPP) within OMB, created an interagency working group to develop strategies for unbundling contracts. The OMB produced a report⁵ with a letter to the President of the United States, dated Oct. 29, 2002; with their efforts (which included notice in the Federal Register for public comments and public meeting), and resulting strategies. The report stated, “A strategy for unbundling contracts must recognize the combined challenges of a reduced acquisition workforce and the need to maintain an overall acquisition system that is fair efficient and transparent. We cannot afford to revert back to the paperwork and labor-intensive system of the past. Nor can we pursue operational efficiencies at the expense of reducing small business opportunities. The challenge is to strike an appropriate balance between operational efficiency, opportunity and fairness.” The cover letter in the report to the President stated, “the enclosed report provides an aggressive strategy for . . . mitigating the effects of necessary contract bundling. The recommendations propose . . . to ensure maximum compliance with current contract bundling laws and full use of the resources . . . ” ⁵ Contract Bundling—A Strategy for Increasing Federal Contracting Opportunities for Small Business, October 2002; Executive Office of the President, Office of Management and Budget, Office of Federal Procurement Policy.

Presently, some of the proposed strategies in the report are in the process of being incorporated in the Federal Acquisition Regulations (FAR's) through proposed rules. The analysis of the proposed rules⁶, published in the Federal Acquisition Register, indicates the following: ⁶ Federal Register/Vol. 68, No. 21/Friday, Jan. 31, 2003/Proposed Rules, page 5141, Item C. Regulatory Flexibility Act, analysis item 6.

6. Description of Any Significant Alternatives to the Proposed Rule Which Accomplish the Stated Objectives of Applicable Statutes and Which Minimize the Rule's Economic Impact on Small Entities.

Response:

Currently there are no practical alternatives that will accomplish the objectives of this proposed rule.

Clearly, there is a need to accomplish the combined goals of meeting cost savings, performance, operational-efficiencies as well as socioeconomics of the public sector. There is also an absence of such a mechanism that can accomplish all of these goals. This invention meets these goals, separately and/or together; concurrently; and provides a practical alternative mechanism that the public sector desires.

### SUMMARY OF THE INVENTION

This invention is an automated and integrated system of means, methods, apparatus and procedures to optimize the process of acquisition, conducted in a central manner. The system optimizes the acquisition of good/s, work/s, commodity/ies and service/s for the public and private sector in the marketplace. These tangible and intangible substance/s are acquired for one or multiple assignment/s, project/s, purchase-order/s, contract/s, requisition/s etc. The system is flexible in allowing acquisitions in different ways. It is capable of increasing participation of sellers. It is integrated within itself and with other means, methods, apparatus and procedures to conduct business, trade and commerce. The system also provides associated functions of acquisition, procurement and purchasing that include but are not limited to analytics, oversight etc. It provides several advantages over the present way/s of acquisition.

### Objects of the Invention

Accordingly, it is a primary object of the present invention to provide a new and novel system and method for providing an efficient market at a given time—when the buyer has a real acquisition offer (rather than speculative demand and supply); and getting the best response from many sellers with increasing participation of smaller sellers, at a given time—rather than buyer/s locking in selected seller/s with long-term open-ended contracts.

It is a further object of the present invention to provide a system and method as characterized above which provides an efficient market for buyers and sellers and for given good/s, work/s, commodity/ies and/or service/s at a specific given time within a single or multiple assignment/s, project/s, purchase-order/s, requisition/s etc., even when single or multiple assignment/s, project/s, purchase-order/s, requisition/s etc. contain a mixture of good/s work/s, commodity/ies and/or service/s.

It is a further object of the present invention to provide a system and method as characterized above which provides a fair, on-going and rapidly-created market of multiple sized and multiple nature of offerings for acquisition.

It is a further object of the present invention to provide a system and method as characterized above which provides new and/or modified single or multiple assignment/s, project/s, purchase-order/s, requisition/s etc created within minutes of each other, to the marketplace—instead of relying on long-term open-ended negotiated contracts (for the possibility, but not the guarantee by buyers of possible offers to procure over a long-term, one to three years, and at a pre-set price), with advantages to the buyer but not the seller.

It is a further object of the present invention to provide a system and method as characterized above which provides efficiency of timing and optimization of the market for each assignment/s, project/s, purchase-order/s, requisition/s etc. based on markets and market-conditions.

It is a further object of the present invention to provide a system and method as characterized above which assists in providing and maintaining the management and financial integrity and accuracy of the transactions undergone by the component/s belonging to each assignment/s, project/s, purchase-order/s, requisition/s etc. as well as the whole assignment/s, project/s, purchase-order/s, requisition/s etc.

It is a further object of the present invention to provide a system and method as characterized above which assists in providing records of transactions, both in real-time as well as archiving and restoring such records and which provides transparency and accountability for all transactions at all steps.

It is a further object of the present invention to provide a system and method as characterized above which assists in providing supporting analysis of the transaction that may be fully or partially disclosed to the participant/s as appropriate to each assignment/s, project/s, purchase-order/s, requisition/s etc.

It is a further object of the present invention to provide a system and method as characterized above which assists in providing a market for sellers who would not know of selling opportunities otherwise by reaching wider into the specific market and deeper into the tiers within that market, thereby increasing the ability of very small sellers and niche-sellers to participate more directly in business trade and commerce.

It is a further object of the present invention to provide a system and method as characterized above which provides increased participation of sellers via unbundled multiplicity of the Assignment/s, Project/s, Purchase-order/s, Requisition/s etc., which allows more sellers to participate by spreading out solicitations for the unbundled components, rather than the single or multiple original and/or piggy-backed assignment/s, project/s, purchase-order/s and/or requisition/s

It is a further object of the present invention to provide a system and method as characterized above which assists in providing a transaction rather than merely a search and find function between a buyer and seller.

It is a further object of the present invention to provide a system and method as characterized above which assists in providing a transaction that is a procurement in that it provides the facilitation and integration of functions that precede and follow the purchasing function.

It is a further object of the present invention to provide a system and method as characterized above which assists in providing increased productivity to the buyer by efficiently processing the work that was either time-consuming or could not be done and increases productivity to the seller by facilitating larger unit transactions for a given overhead of per unit production and per unit logistics, material handling, transportation and inventory cost.

It is a further object of the present invention to provide a system and method as characterized above which assists in providing a market that is as large or as small as desired by the buyer; this market could be local, regional, national and/or multinational.

It is a further object of the present invention to provide a system and method as characterized above which assists in providing control of the process of procurement, which is desired by large public and private organizations such as the Federal Government or large ‘Developmental Banks’, who manage the critical act of decision making on procuring appropriately with public funds.

It is a further object of the present invention to provide a system and method as characterized above which gives large public and private organizations a method to control the process for higher efficiency in management of funds and in using efficient processes in savings from their budgeted funds.

It is a further object of the present invention to provide a system and method as characterized above which assists in managing contracts by the judicious use of the existing legal framework.

It is a further object of the present invention to provide a system and method as characterized above which assists in providing an open and competitive approach to the marketplace and complies with the U.S. Sherman Antitrust Act and the U.S. Robinson-Patman Act.

It is a further object of the present invention to provide a system and method as characterized above which assists in providing means, methods, apparatus procedures etc. to prevent the disadvantages of Bundling Assignment/s, Project/s, Purchase-Order/s and/or Requisition/s into large bundles for procurement that may only be responded by and awarded to large organizations with large resources.

It is a further object of the present invention to provide a system and method as characterized above which assists in providing means, methods, apparatus procedures etc. to prevent a Monopoly of sellers.

It is a further object of the present invention to provide a system and method as characterized above which assists in providing means, methods, apparatus procedures etc. to prevent a Monopsony of buyer/s.

It is a further object of the present invention to provide a system and method as characterized above which assists in providing and facilitating in bringing the producer closer to the end-user to conduct a transaction in business, trade and commerce that has the capability to bypass intermediaries that do not provide value to the transaction, and yet maintains the integrity of each assignment/s, project/s, purchase-order/s, requisition/s etc. in transacting business, trade and commerce.

It is a further object of the present invention to provide a mechanism for the private and public sectors to concurrently derive the benefits of “contract bundling” and “unbundling of contracts” in addition to meeting socioeconomic goals and opportunities.

Viewed from a first vantage point, it is an object of the present invention to provide a method for optimizing procurement transactions among a plurality of projects, the steps including: sequestering each procurement component from each project; pooling the procurement components from the projects into a plurality of bundles, wherein each bundle comprises a single procurement component, and wherein each procurement component contains a reference to its originating project; matching each bundle to a plurality of sellers; conducting procurement transactions for the bundles with the plurality of sellers according to the procurement components; separating the bundles into procurement components, wherein the procurement components are grouped by the originating projects; and assembling the projects from the procurement components.

Viewed from a second vantage point, it is an object of the present invention to provide a network for optimizing procurement transactions among a plurality of projects, comprising, in combination: means for accepting a plurality of projects, each project comprised of a plurality of procurement components; means for sequestering each procurement component from each project; means for combining the procurement components from the projects into bundles, wherein each bundle comprises a single procurement component, and wherein each procurement component contains an originating project reference; means for associating each bundle with a plurality of sellers; means for conducting procurement transactions with plurality of sellers with respect to bundles, each procurement transaction dependent on each procurement component; means for redistributing the procurement components from the bundles, wherein redistribution is controlled by each originating project reference; and means for assembling each project from the procurement components.

Viewed from a third vantage point, it is an object of the present invention to provide a segment of a value optimization network, wherein the value optimization network optimizes value in transactions, the segment comprising, in combination: means for accepting a plurality of projects, each project comprised of a plurality of procurement components; means for sequestering each procurement component from each project; means for combining the procurement components from the plurality of projects into packages, wherein each package comprises a single procurement component, and wherein each procurement component contains an originating project reference; means for associating each package with a plurality of sellers; means for conducting procurement transactions with the plurality of sellers with respect to the packages, each procurement transaction dependent on each procurement component; means for redistributing the procurement components from the packages, wherein redistribution is controlled by each originating project reference; means for assembling each project from the procurement components; and means for integrating the segment with the value optimization network, wherein an integrated network derives more value.

These and other objects will be made manifest when considering the following detailed specification when taken in conjunction with the appended drawing figures.

### DESCRIPTION OF THE DRAWINGS

FIG. 1

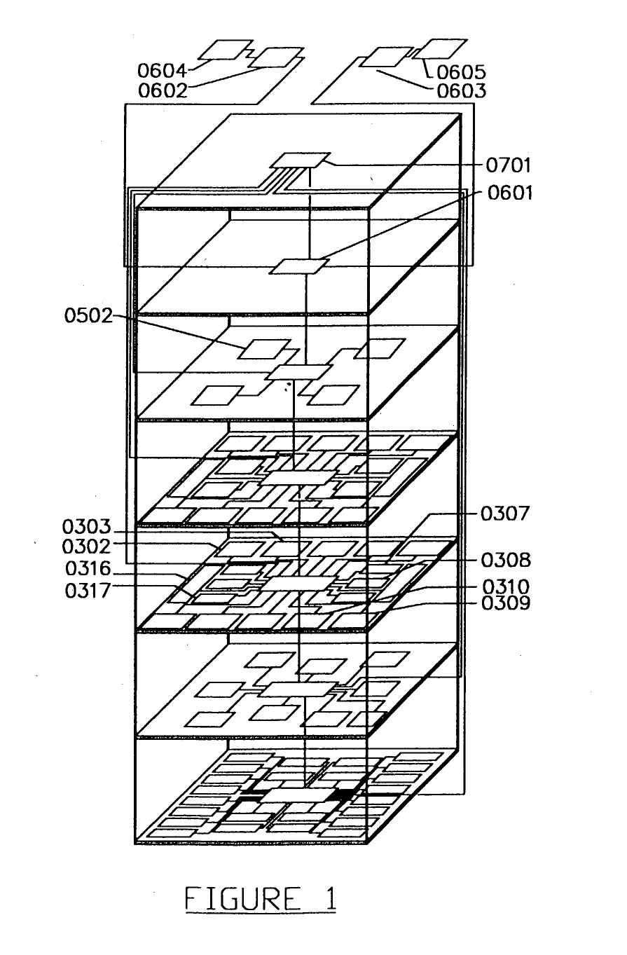

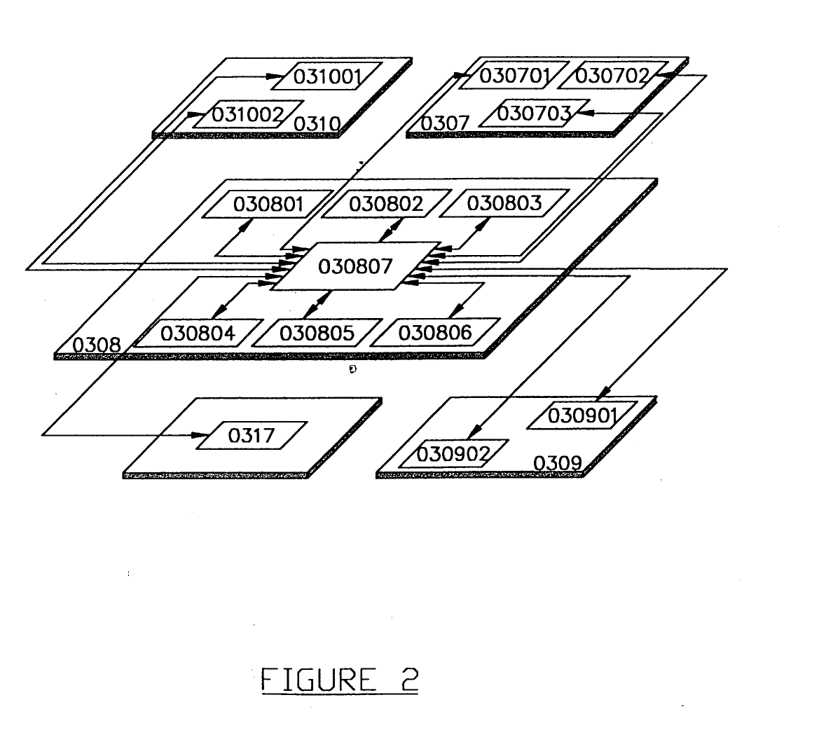

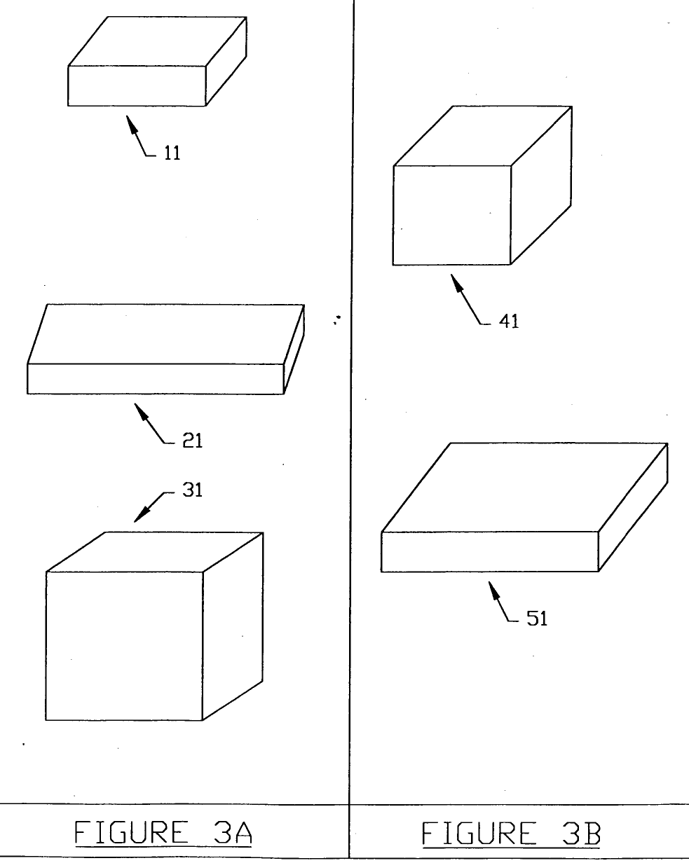

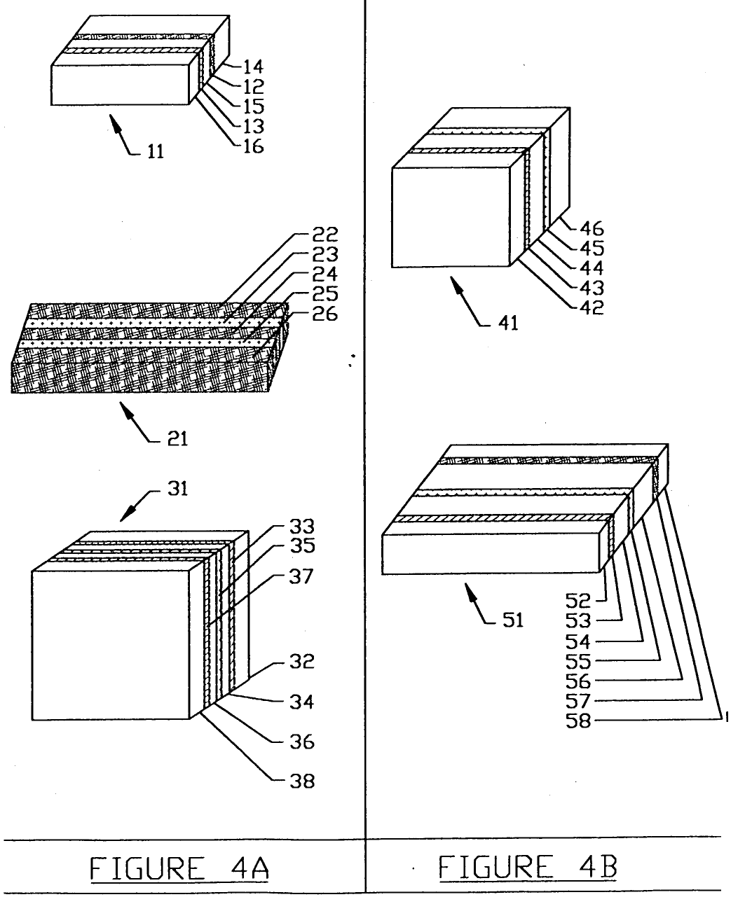

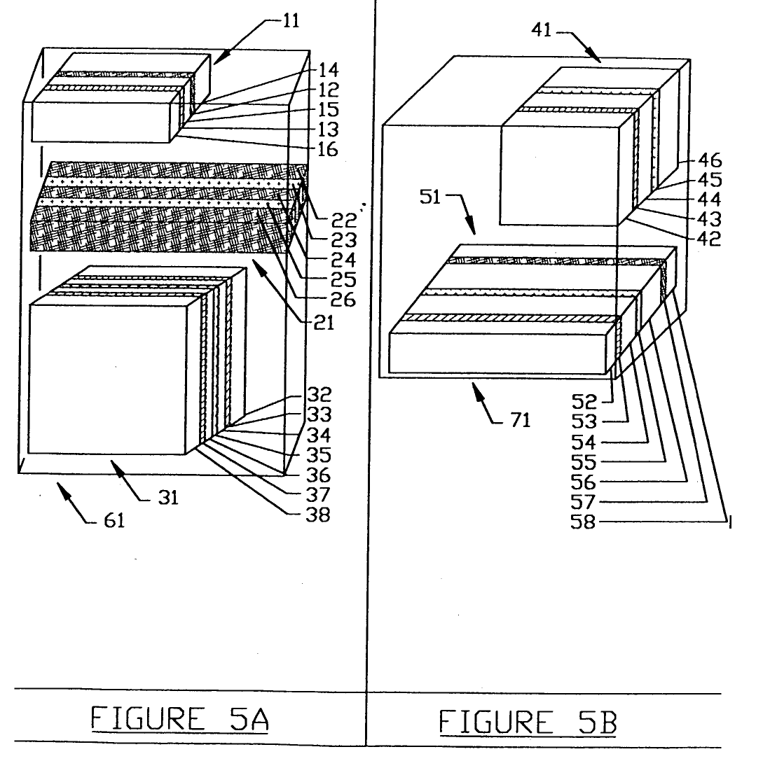

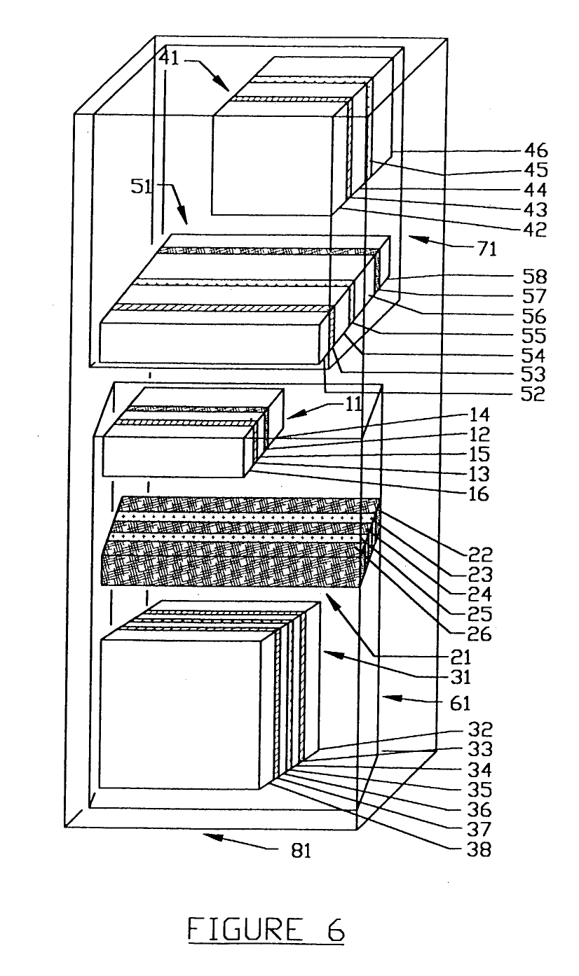

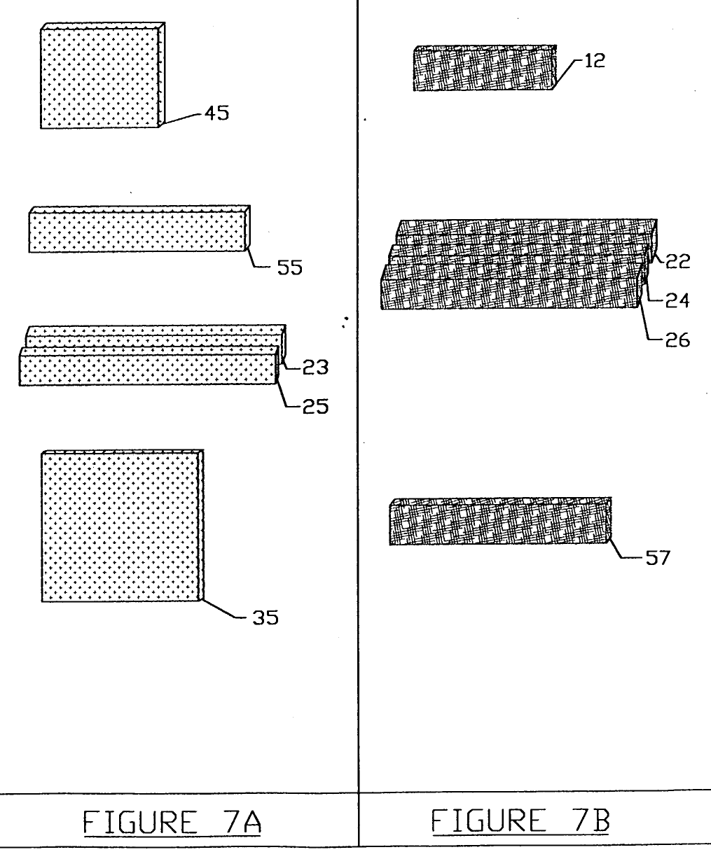

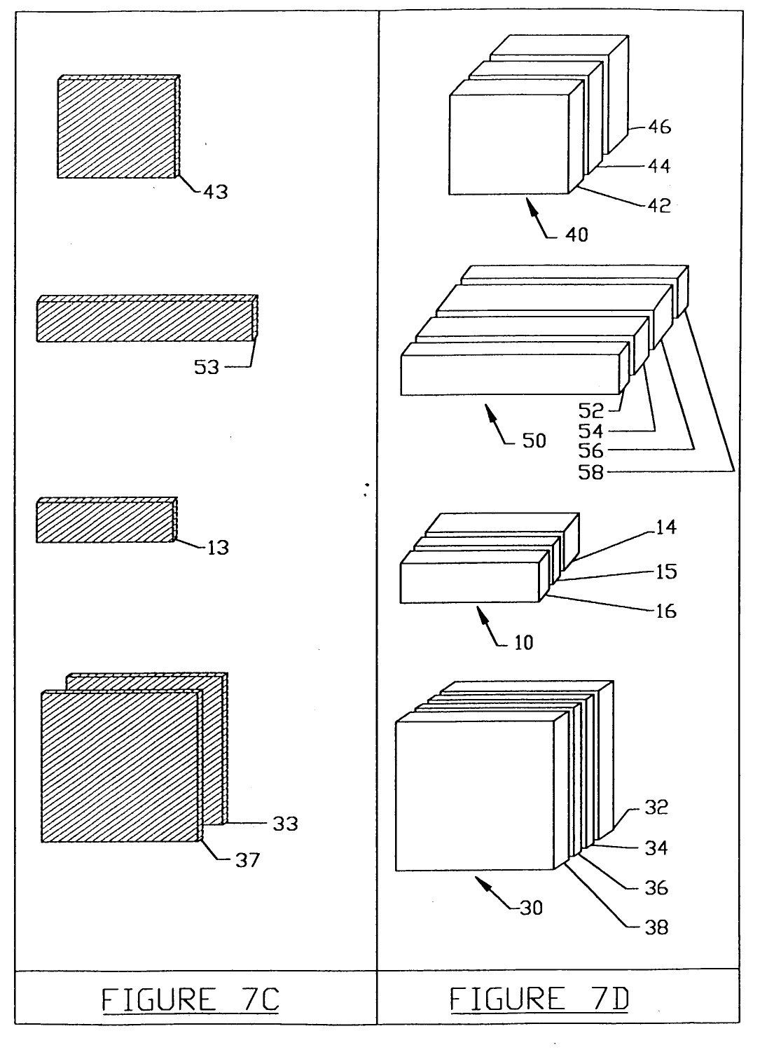

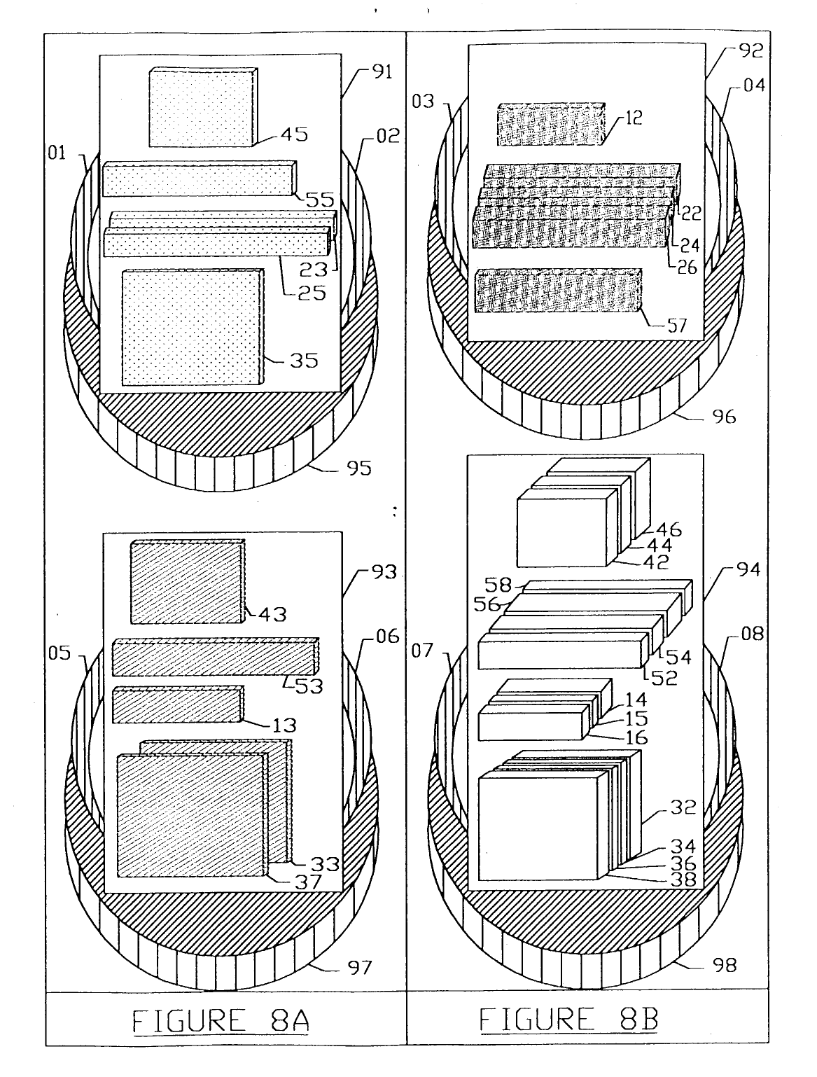

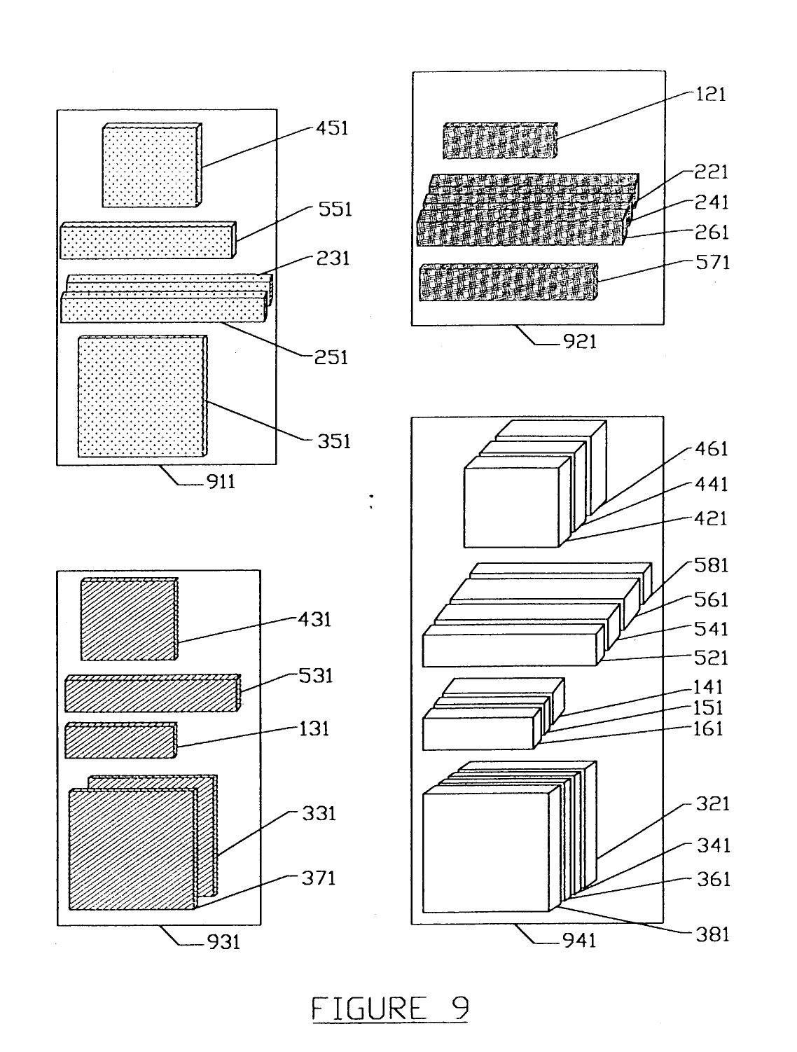

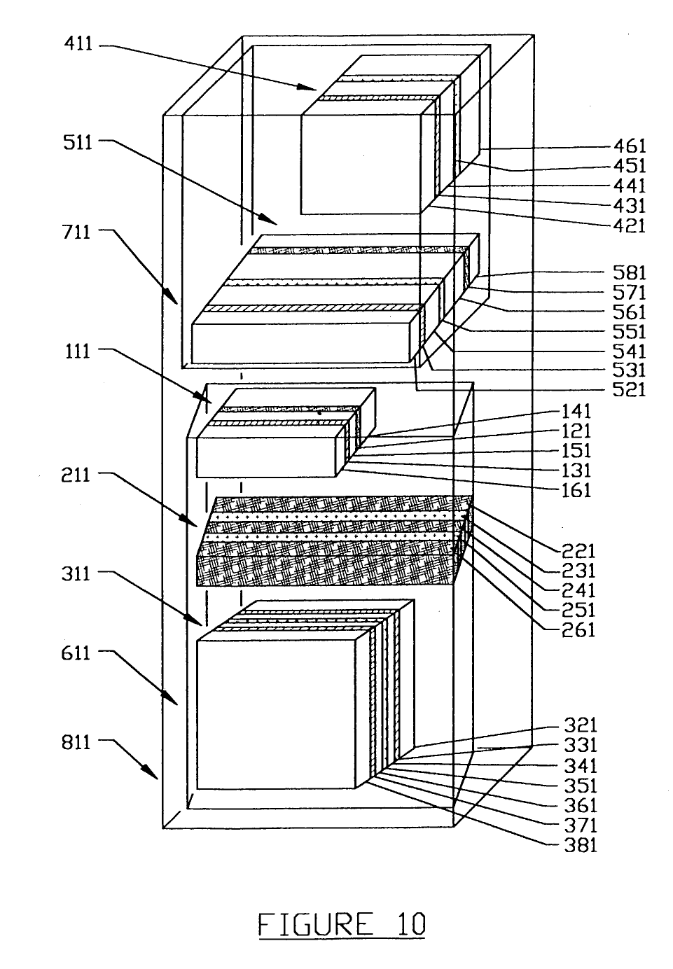

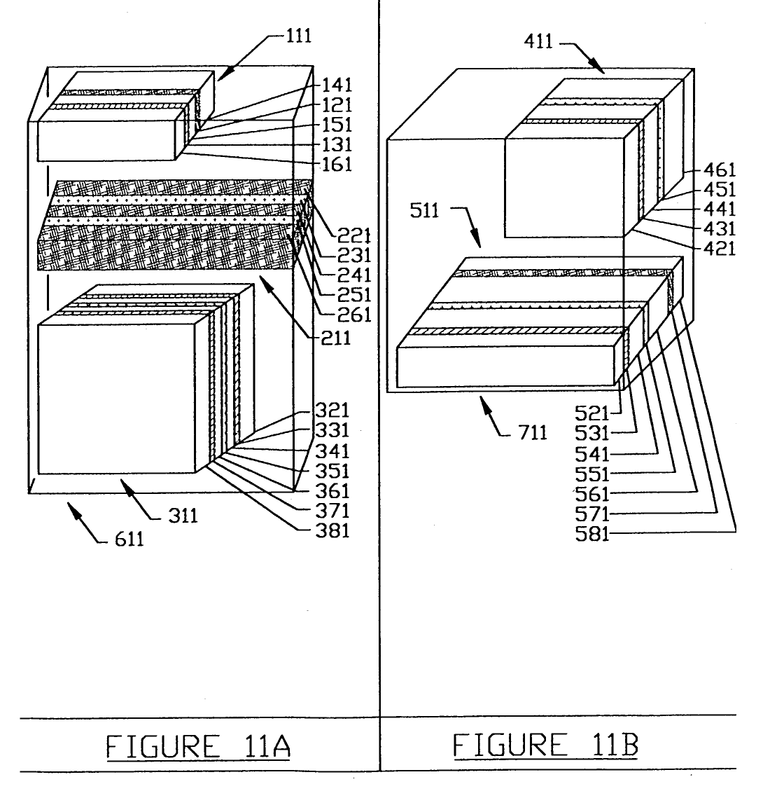

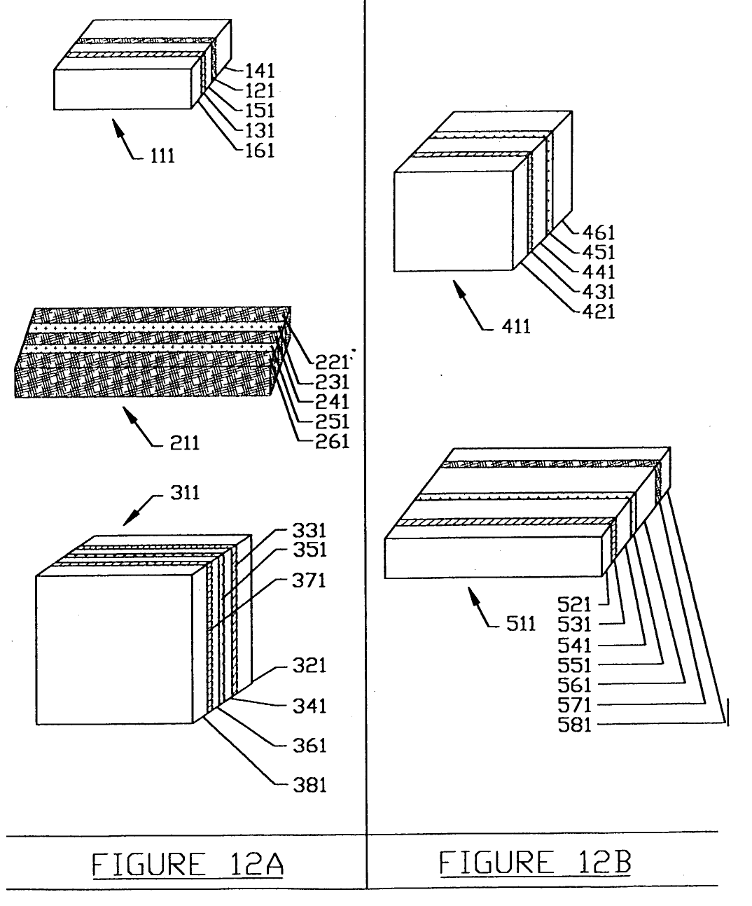

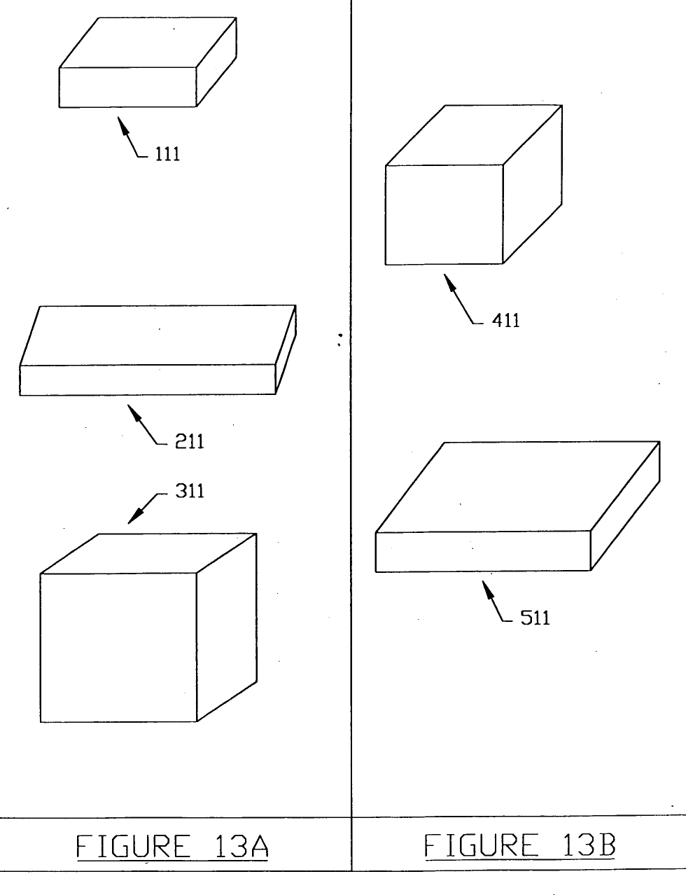

Refer to FIG. 1. This figure and its details represent a value providing network. This invention links with and utilizes the facets and all of their functions, associations, links, communications etc. These facets include, but are not limited to the facets noted below:

Facet 0302—An Assembly consisting of the means, methods and procedures of the function of ‘Needs Assessment’ within an organization. Such functionality is processed with an additional focus on Creation and Tracking of Capital. This facet also represents its two-directional communication and exchange of data and information with other facets.

Facet 0303—An Assembly consisting of the means, methods and procedures of the function of ‘Budgeting’ within an organization. Such functionality is processed with an additional focus on Creation and Tracking of Capital. This facet also represents its two-directional communication and exchange of data and information with other facets.

Facet 0307—Assembly consisting of the means, methods and procedures of the function of ‘Resources and Resourcing’ within an organization. Such functionality is processed with an additional focus on Creation and Tracking of Capital. This facet also represents its two-directional communication and exchange of data and information with other facets.

Facet 0308—Assembly consisting of the means, methods and procedures of the function of ‘Procurement’ within an organization. Such functionality is processed with an additional focus on Creation and Tracking of Capital. This facet also represents its two-directional communication and exchange of data and information with other facets.

Facet 0309—Assembly consisting of the means, methods and procedures of the function of ‘Sales’ within an organization. Such functionality is processed with an additional focus on Creation and Tracking of Capital. This facet also represents its two-directional communication and exchange of data and information with other facets.

Facet 0310—Assembly consisting of the means, methods and procedures of the function of ‘Contracts and Contracts Management’ within an organization. Such functionality is processed with an additional focus on Creation and Tracking of Capital. This facet also represents its two-directional communication and exchange of data and information with other facets.

Facet 0316—Assembly consisting of the means, methods and procedures of the function of ‘Markets and Market Conditions’ within an organization. Such functionality is processed with an additional focus on Creation and Tracking of Capital. This facet also represents its two-directional communication and exchange of data and information with other facets.

Facet 0317—Assembly consisting of the means, methods and procedures of the function of ‘Analytics and Reporting’ within an organization. Such functionality is processed with an additional focus on Creation and Tracking of Capital. This facet also represents its two-directional communication and exchange of data and information with other facets.

Facet 0502—Assembly consisting of the means, methods and procedures of the Network Set-up function of an organization. This assembly communicates and exchanges data and information with all other assemblies at this level as well as other assemblies at other levels

Facet 0601—Assembly consisting of the means, methods and procedures of the Network Administration function of an organization. This assembly communicates and exchanges data and information with all other assemblies at this level as well as other assemblies at other levels. It communicates and exchanges data and information independently with the assemblies on level VII. Refer to facet 0701. This facet functions as an administrator of the flow of data and information exchanging in and out of an organization.

Facet 0602—Assembly consisting of the means, methods and procedures of the Information and Data Propagation function of an organization. In this configuration it represents propagating data and information upstream (to the left) to other participants. This assembly communicates and exchanges data and information with other assemblies at this level as well as other assemblies at other levels within the organization and with assemblies outside the organization. This assembly provides the means, methods, procedures etc. to propagate data and information.

Facet 0603—Assembly consisting of the means, methods and procedures of the Information and Data Propagation function of an organization. In this configuration it represents propagating data and information downstream (to the right in the figure) to other participants. This assembly communicates and exchanges data and information with all other assemblies at this level as well as other assemblies at other levels within the organization and with assemblies outside the organization. This assembly provides the means, methods, procedures etc. to propagate data and information.

Facet 0604—Assembly consisting of the means, methods and procedures of the Facilitation functions of an organization. In this configuration it represents facilitating data and information upstream (to the left in the figure) to other participants. This assembly communicates and exchanges data and information with all other assemblies at this level as well as other assemblies at other levels within the organization and with assemblies outside the organization. This assembly provides the means, methods, procedures etc. to facilitate data and information.

Facet 0605—Assembly consisting of the means, methods and procedures of the Facilitation functions of an organization. In this configuration it represents facilitating data and information downstream (to the right) to other participants. This assembly communicates and exchanges data and information with all other assemblies at this level as well as other assemblies at other levels within the organization and with assemblies outside the organization. This assembly provides the means, methods, procedures etc. to facilitate data and information.

Facet 0701—Assembly consisting of the means, methods and procedures of the Oversight functions of an organization. This assembly communicates and exchanges data and information with all other assemblies at this level as well as other assemblies at other levels. The functionality of this assembly is unique. Modules within this assembly have special secure features both in access to them and in their functioning. Modules allow for ‘overseeing’ all other activities at all levels within this system and to those that it is connected external to its immediate system. The assembly can provide ‘audit trails’ both archived and in real time. The assembly is flexible such that it may or may not be connected to any other part of internal or external systems without affecting their usage or performance.

FIG. 2

Refer to FIG. 2. This figure expands some parts of FIG. 1 into more details. FIG. 2 includes, but is not limited to the Assemblies and their functional inter-relationships as they are utilized in this invention.

These Assemblies and their sub-set Assemblies communicate and exchange data and information with all other assemblies shown in FIG. 2.

These Assemblies and their sub-set Assemblies also communicate and exchange data and information with other assemblies including but not limited to those identified in FIG. 1.

Facet 0307—Assembly described in FIG. 1 as Facet 0307. This facet contains sub-sets that function together. These sub-sets are associated with and function with the facet 0307.

Facet 030701—Sub-set of Assembly described as Facet 0307. The subject matter consists of a system of means, methods and procedures for coding for goods, works and services.

Facet 030702—Sub-set of Assembly described as Facet 0307. The subject matter consists of a system of means, methods and procedures of targeted-resourcing.

Facet 030703—Sub-set of Assembly described as Facet 0307. The subject matter consists of a system of means, methods and procedures of evaluation of resources.

Facet 0308—Assembly described in FIG. 1 as Facet 0308. This facet contains sub-sets that function together. These sub-sets are associated with and function with the facet 0308.

Facet 030801—Sub-set of Assembly described as Facet 0308. The subject matter consists of a system of means, methods and procedures of an upstream-tier-system.

Facet 030802—Sub-set of Assembly described as Facet 0308. The subject matter consists of a system of means, methods, apparatus and procedures of central dispensation of multiple procurement and/or sales techniques.

Facet 030803—Sub-set of Assembly described as Facet 0308. The subject matter consists of a system of means, methods and procedures of specifications and specifying good/s, work/s, commodity/ies and service/s.

Facet 030804—Sub-set of Assembly described as Facet 0308. The subject matter consists of a system of means, methods and procedures of virtual pricing.

Facet 030805—Sub-set of Assembly described as Facet 0308. The subject matter consists of a system of means, methods and procedures of trading baskets for procurement from a buyer.

Facet 030806—Sub-set of Assembly described as Facet 0308. The subject matter consists of a system of means, methods and procedures of pricing.

Facet 030807—Sub-set of Assembly described as Facet 0308. This assembly consists of a system of means, methods and procedures of optimized central procurement. It provides the means, methods, procedures etc. to facilitate data and information described by, but not limited to: FIG. 3A, FIG. 3B, FIG. 4A, FIG. 4B, FIG. 5A, FIG. 5B, FIG. 6, FIG. 7A, FIG. 7B, FIG. 7C, FIG. 7D, FIG. 8A, FIG. 8B, FIG. 9, FIG. 10, FIG. 11A, FIG. 11B, FIG. 12A, FIG. 12B, FIG. 13A and FIG. 13B.

Facet 0309—Assembly described in FIG. 1 as Facet 0309. This facet contains sub-sets that function together. These sub-sets are associated with and function with the facet 0309.

Facet 030901—Sub-set of Assembly described as Facet 0309. The subject matter consists of a system of means, methods and procedures of a downstream-tier-system.

Facet 030902—Sub-set of Assembly described as Facet 0309. The subject matter consists of a system of means, methods and procedures of trading baskets for sales from a seller.

Facet 0310—Assembly described in FIG. 1 as Facet 0310. This facet contains sub-sets that function together. These sub-sets are associated with and function with the facet 0310.

Facet 031001—Sub-set of Assembly described as Facet 0310. The subject matter consists of a system of means, methods and procedures of contract evaluation.

Facet 031002—Sub-set of Assembly described as Facet 0310. The subject matter consists of a system of means, methods and procedures of contract preparation.

Facet 0317—Assembly described in FIG. 1 as Facet 0317. This facet contains sub-sets that function together. These sub-sets provide the Analytics and Reporting function within an organization.

FIG. 3A

This figure includes but is not limited to more details of the system of means, methods and procedures contained in facet 030807 in FIG. 2.

This figure shows three facets.

Facet 11 represents a project, assignment, purchase-order, contract etc. that has to be procured. This facet may consist of good/s, work/s, commodity/ies and/or service/s or a complete or partial combination of the three.

Facet 21 represents another project, assignment, purchase-order, contract etc. that has to be procured. This facet may consist of good/s, work/s, commodity/ies and/or service/s or a complete or partial combination of the three.

Facet 31 represents another project, assignment, purchase-order, contract etc. that has to be procured. This facet may consist of good/s, work/s, commodity/ies and/or service/s or a complete or partial combination of the three.

The three facets represent a variety of size and shapes. This represents that the three projects, assignments, purchase-orders may vary in physical size of quantity and the specifications of each may vary regarding content, quality, delivery date, delivery location and other variables associated with the project, assignment, purchase-order etc. Furthermore the timing of purchase may not necessarily be concurrent for each individual project, assignment or purchase-order.

The three facets may or may not be fiscally responsible to, or originate from the same buyer.

FIG. 3B

This figure includes but is not limited to more details of the system of means, methods and procedures contained in facet 030807 in FIG. 2.

This figure shows two facets.

Facet 41 represents a project, assignment, purchase-order, contract etc. that has to be procured. This facet may consist of good/s, work/s, commodity/ies and/or service/s or a complete or partial combination of the three.

Facet 51 represents another project, assignment, purchase-order, contract etc. that has to be procured. This facet may consist of good/s, work/s, commodity/ies and/or service/s or a complete or partial combination of the three.

The two facets represent different sizes and shapes. This represents that the two projects, assignments, purchase-orders may vary in physical size of quantity and the specifications of each may vary regarding content, quality, delivery date, delivery location and other variables associated with the project, assignment, purchase-order etc. The two facets may or may not be fiscally responsible to, or originate from the same buyer.

The approximate timing of the procurements of facet 41 and facet 51 are such that they may be ‘piggy-backed’ on another unrelated procurement. These facets represent a ‘piggy-backed procurement’ on another unrelated procurement such as that of Facet 11, Facet 21 and Facet 31 shown in FIG. 3A.

FIG. 4A

This figure includes but is not limited to more details of the system of means, methods and procedures contained in facet 030807 in FIG. 2.

Refer to FIG. 4A.

Facet 11, Facet 21 and Facet 31 represent the corresponding Facet 11, Facet 21 and Facet 31 of FIG. 3A with the same representation and meaning as that in FIG. 3A.

Facet 11 contains components represented by Facet 12, Facet 13, Facet 14, Facet 15 and Facet 16.

Facet 12 represents a unique component of the overall project, assignment, contract, purchase-order etc. represented by facet 11. This component may have such characteristics as a unique specialty market, a unique manufacturer or it may be complete and independent good/s, work/s, commodity/ies and/or service/s such that no additional value is added or needs to be added by any intermediary, so as to be of use to the end-user of that component.

Facet 13 also represents a unique but different component, of the overall project, assignment, contract, purchase order etc., represented by facet 11. This component may also have such characteristics as a unique specialty market, a unique manufacturer or it may be complete and independent good/s, work/s, commodity/ies and/or service/s such that no additional value is added or needs to be added by any intermediary, so as to be of use to the end-user of that component.

Facet 14, Facet 15 and Facet 16 represent remaining components of the overall project, assignment, contract, purchase order etc., of normal good/s work/s, commodity/ies and/or services. These facets are not unique and value may be added by intermediaries, so as to be of use to the end-user of the components

Facet 21 contains components represented by Facet 22, Facet 23, Facet 24, Facet 25 and Facet 26.

Facet 22, Facet 24 and Facet 26 represent unique components of the overall project, assignment, contract, purchase order etc., represented by facet 21. These components may have such characteristics as a unique specialty market, a unique manufacturer or it may be complete and independent good/s, work/s, commodity/ies and/or service/s such that no additional value is added or needs to be added by any intermediary, so as to be of use to the end-user of that component. These facets have similar characteristics to that of Facet 12.

Facet 23 and Facet 25 also represent unique but different components of the overall project, assignment, contract, purchase-order etc. represented by facet 21. These components may have such characteristics as a unique specialty market, a unique manufacturer or it may be complete and independent good/s, work/s, commodity/ies and/or service/s such that no additional value is added or needs to be added by any intermediary, so as to be of use to the end-user of that component.

Facet 31 contains components represented by Facet 32, Facet 33, Facet 34, Facet 35, Facet 36, Facet 37 and Facet 38.

Facet 33, Facet 35 and Facet 37 represent unique components of the overall project, assignment, contract, purchase-order etc. represented by facet 31. These components may have such characteristics as a unique specialty market, a unique manufacturer or it may be complete and independent good/s, work/s, commodity/ies and/or service/s such that no additional value is added or needs to be added by any intermediary, so as to be of use to the end-user of that component. Facet 33 and Facet 37 have similar characteristics to that of Facet 13. Facet 35 has similar characteristics to that of Facet 23 and Facet 25.

Facet 32, Facet 34, Facet 36 and Facet 38 represent remaining components of the overall project, assignment, contract, purchase order etc., of normal good/s work/s, commodity/ies and/and/or services represented by Facet 31. These facets are not unique and value may be added by intermediaries, so as to be of use to the end-user of the components

FIG. 4B

This figure includes but is not limited to more details of the system of means, methods and procedures contained in facet 030807 in FIG. 2.

Facet 41 and Facet 51 represent the corresponding Facet 41 and Facet 51 of FIG. 3B with the same representation and meaning as that in FIG. 3B.

Facet 41 contains components represented by Facet 42, Facet 43, Facet 44, Facet 45 and Facet 46.

Facet 43 represents a unique component of the overall project, assignment, contract, purchase order etc., represented by facet 41. This component may have such characteristics as a unique specialty market, a unique manufacturer or it may be complete and independent good/s, work/s, commodity/ies and/or service/s such that no additional value is added or needs to be added by any intermediary, so as to be of use to the end-user of that component. This facet has characteristics that are similar to Facet 13, Facet 33 and Facet 37 shown in FIG. 4A.

Facet 45 also represents a unique but different component, of the overall project, assignment, contract, purchase order etc., represented by facet 41. This component may also have such characteristics as a unique specialty market, a unique manufacturer or it may be complete and independent good/s, work/s, commodity/ies and/or service/s such that no additional value is added or needs to be added by any intermediary, so as to be of use to the end-user of that component. This facet has characteristics that are similar to Facet 23, Facet 25 and Facet 35 shown in FIG. 4A.

Facet 42, Facet 44 and Facet 46 represent remaining components of the overall project, assignment, contract, purchase order etc., of normal good/s work/s, commodity/ies and/or services represented by Facet 41. These facets are not unique and value may be added by intermediaries, so as to be of use to the end-user of the components

Facet 51 contains components represented by Facet 52, Facet 53, Facet 54, Facet 55, Facet 56, Facet 57 and Facet 58.

Facet 53, Facet 55 and Facet 57 represent unique components of the overall project, assignment, contract, purchase order etc., represented by facet 51. These components may have such characteristics as a unique specialty market, a unique manufacturer or it may be complete and independent good/s, work/s, commodity/ies and/or service/s such that no additional value is added or needs to be added by any intermediary, so as to be of use to the end-user of that component.

Facet 53 has similar characteristics to that of Facet 43. It also has similar characteristics of Facet 13, Facet 33 and Facet 37 shown in FIG. 4A.

Facet 55 has similar characteristics to that of Facet 45. It also has similar characteristics of Facet 23, Facet 25 and Facet 35 shown in FIG. 4A.

Facet 57 has similar characteristics of Facet 12, Facet 22, Facet 24 and Facet 26 shown in FIG. 4A.

Facet 52, Facet 54, Facet 56 and Facet 58 represent remaining components of the overall project, assignment, contract, purchase order etc., of normal good/s work/s, commodity/ies and/and/or services represented by Facet 51. These facets are not unique and value may be added by intermediaries, so as to be of use to the end-user of the components

FIG. 5A

This figure includes but is not limited to more details of the system of means, methods, apparatus and procedures contained in facet 030807 in FIG. 2.

Facet 61 represents the aggregation of the Facet 11, Facet 21 and Facet 31. This facet represents the beginning or original assignment/s, project/s, contract/s purchase order/s etc.

Facet 11, Facet 21 and Facet 31 represent the corresponding Facet 11, Facet 21 and Facet 31 of FIG. 3A and FIG. 4A; with the same representation and meaning as that in FIG. 3A and FIG. 4A.

The corresponding components within each of the three facets is represented by Facets 12, 13, 14, 15, 16; Facets 22, 23, 24, 25, 26; and Facets 32, 33, 34, 35, 36, 37, 38. These facets represent and mean the same as that in FIG. 4A.

FIG. 5B

This figure includes but is not limited to more details of the system of means, methods, apparatus and procedures contained in facet 030807 in FIG. 2.

Facet 71 represents the aggregation of the Facet 41 and Facet 51. This facet represents the piggy-backed assignment/s, project/s, contract/s, purchase order/s etc.

Facet 41 and Facet 51 represent the corresponding Facet 41 and Facet 51 of FIG. 3B and FIG. 4B; with the same representation and meaning as that in FIG. 3B and FIG. 4B.

The corresponding components within each of the two facets is represented by Facets 42, 43, 44, 45, 46; and Facets 52, 53, 54, 55, 56, 57, 58. These facets represent and mean the same as that in FIG. 4B.

FIG. 6

This figure includes but is not limited to more details of the system of means, methods, apparatus and procedures contained in facet 030807 in FIG. 2.

Facet 81 represents the aggregation of Facet 61 and Facet 71 with the same meaning and representation as that in FIG. 5A and FIG. 5B.

The corresponding components within each of the Facet 11, Facet 21 and Facet 31 is respectively represented by Facets 12, 13, 14, 15, 16; Facets 22, 23, 24, 25, 26; and Facets 32, 33, 34, 35, 36, 37, 38; with the same representation and meaning as FIG. 5A. The corresponding components within each of the Facet 41 and Facet 51 is respectively represented by Facets 42, 43, 44, 45, 46; and Facets 52, 53, 54, 55, 56, 57, 58; with the same representation and meaning as FIG. 5B.

FIG. 7A

This figure includes but is not limited to more details of the system of means, methods, apparatus and procedures contained in facet 030807 in FIG. 2.

This figure represents the unique components within facet 81 of FIG. 6 that are similar in characteristics. These include:

Facet 45 is a unique component of the assignment, project, contract, purchase-order etc., represented by Facet 41, shown in FIG. 6.

Facet 55 is a unique component of the assignment, project, contract, purchase-order etc., represented by Facet 51, shown in FIG. 6.

Facet 23 is a unique component of the assignment, project, contract, purchase-order etc., represented by Facet 21, shown in FIG. 6.

Facet 25 is a unique component of the assignment, project, contract, purchase-order etc., represented by Facet 21, shown in FIG. 6.

Facet 35 is a unique component of the assignment, project, contract, purchase-order etc., represented by Facet 31, shown in FIG. 6.

FIG. 7B

This figure includes but is not limited to more details of the system of means, methods and procedures contained in facet 030807 in FIG. 2.

This figure represents the unique components within facet 81 of FIG. 6 that are similar in characteristics. These include:

Facet 57 is a unique component of the assignment, project, contract, purchase-order etc., represented by Facet 51, shown in FIG. 6.

Facet 12 is a unique component of the assignment, project, contract, purchase-order etc., represented by Facet 11, shown in FIG. 6.

Facet 22 is a unique component of the assignment, project, contract, purchase-order etc., represented by Facet 21, shown in FIG. 6.

Facet 24 is a unique component of the assignment, project, contract, purchase-order etc., represented by Facet 21, shown in FIG. 6.

Facet 26 is a unique component of the assignment, project, contract, purchase-order etc., represented by Facet 21, shown in FIG. 6.

FIG. 7C

This figure includes but is not limited to more details of the system of means, methods and procedures contained in facet 030807 in FIG. 2.

This figure represents the unique components within facet 81 of FIG. 6 that are similar in characteristics. These include:

Facet 43 is a unique component of the assignment, project, contract, purchase-order etc., represented by Facet 41, shown in FIG. 6.

Facet 53 is a unique component of the assignment, project, contract, purchase-order etc., represented by Facet 51, shown in FIG. 6.

Facet 13 is a unique component of the assignment, project, contract, purchase-order etc., represented by Facet 11, shown in FIG. 6.

Facet 33 is a unique component of the assignment, project, contract, purchase-order etc., represented by Facet 31, shown in FIG. 6.

Facet 37 is a unique component of the assignment, project, contract, purchase-order etc., represented by Facet 31, shown in FIG. 6.

FIG. 7D

This figure includes but is not limited to more details of the system of means, methods and procedures contained in facet 030807 in FIG. 2.

This figure represents the left-over and non-unique components within facet 81 of FIG. 6. Value may be added to these components by intermediaries, so as to be of use to the end-user of the components. These include:

Facet 40 is the left-over collective of components represented by Facet 42, Facet 44 and Facet 46. These facets represent the remaining components of the overall project, assignment, contract, purchase order etc., of normal good/s work/s, commodity/ies and/or services represented by Facet 41 shown in FIG. 6. These facets are not unique and value may be added by intermediaries, so as to be of use to the end-user of the components.

Facet 50 is the left-over collective of components represented by Facet 52, Facet 54, Facet 56 and Facet 58. These facets represent the remaining components of the overall project, assignment, contract, purchase order etc., of normal good/s work/s, commodity/ies and/or services represented by Facet 51 shown in FIG. 6. These facets are not unique and value may be added by intermediaries, so as to be of use to the end-user of the components.

Facet 10 is the left-over collective of components represented by Facet 14, Facet 15 and facet 16. These facets represent the remaining components of the overall project, assignment, contract, purchase order etc., of normal good/s work/s, commodity/ies and/or services represented by Facet 11 shown in FIG. 6. These facets are not unique and value may be added by intermediaries, so as to be of use to the end-user of the components.

Facet 30 is the left-over collective of components represented by Facet 32, Facet 34, Facet 36 and Facet 38. These facets represent the remaining components of the overall project, assignment, contract, purchase order etc., of normal good/s work/s, commodity/ies and/or services represented by Facet 31 shown in FIG. 6. These facets are not unique and value may be added by intermediaries, so as to be of use to the end-user of the components.

FIG. 8A

This figure includes but is not limited to more details of the system of means, methods, apparatus and procedures contained in facet 030807 in FIG. 2.

Facet 91 represents an aggregation of the unique components represented by Facet 45, Facet 55, Facet 23, Facet 25 and Facet 35 shown in FIG. 7A.

Facet 01 represents the unique means methods, apparatus and procedures of procurement and trading assigned to this aggregation that includes, but is not limited by the facet 030802 in FIG. 2.

Facet 02 represents the unique means, methods, apparatus and procedures of targeted resourcing applied to this aggregation that includes, but is not limited by the facet 030702 in FIG. 2.

Facet 95 represents the unique means methods, apparatus and procedures of the first-phase transactions applied to this aggregation in the unique marketplace that includes, but is not limited to Facet 030801, Facet 030804, Facet 030806, and Facet 030901.

Facet 93 represents an aggregation of the unique components represented by Facet 43, Facet 53, Facet 13, Facet 33 and Facet 37 shown in FIG. 7C.

Facet 05 represents the unique means, methods, apparatus and procedures of procurement and trading assigned to this aggregation that includes, but is not limited by the facet 030802 in FIG. 2.

Facet 06 represents the unique means, methods, apparatus and procedures of targeted resourcing applied to this aggregation that includes, but is not limited by the facet 030702 in FIG. 2.

Facet 97 represents the unique means, methods, apparatus and procedures of the first-phase transactions applied to this aggregation in the unique marketplace that includes, but is not limited to Facet 030801, Facet 030804, Facet 030806, and Facet 030901.

FIG. 8B

This figure includes but is not limited to more details of the system of means, methods, apparatus and procedures contained in facet 030807 in FIG. 2.

Facet 92 represents an aggregation of the unique components represented by Facet 57, Facet 12, Facet 22, Facet 24 and Facet 26 shown in FIG. 7B.

Facet 03 represents the unique means, methods, apparatus and procedures of procurement and trading assigned to this aggregation that includes, but is not limited by the facet 030802 in FIG. 2.

Facet 04 represents the unique means, methods, apparatus and procedures of targeted resourcing applied to this aggregation that includes, but is not limited by the facet 030702 in FIG. 2.

Facet 96 represents the unique means, methods, apparatus and procedures of the first-phase transactions applied to this aggregation in the unique marketplace that includes, but is not limited to Facet 030801, Facet 030804, Facet 030806, and Facet 030901.

Facet 94 represents an aggregation of the unique components represented by Facet 42, Facet 44, Facet 46; Facet 52, Facet 54, Facet 56, Facet 58; Facet 14, Facet 15, Facet 16; and Facet 32, Facet 34, Facet 36, Facet 38shown in FIG. 7D.

Facet 07 represents the unique means, methods, apparatus and procedures of procurement and trading assigned to this aggregation that includes, but is not limited by the facet 030802 in FIG. 2.

Facet 08 represents the unique means, methods, apparatus and procedures of targeted resourcing applied to this aggregation that includes, but is not limited by the facet 030702 in FIG. 2.

Facet 98 represents the unique means, methods, apparatus and procedures of the first-phase transactions applied to this aggregation in the unique marketplace that includes, but is not limited to Facet 030801, Facet 030804, Facet 030806, and Facet 030901.

FIG. 9

This figure includes but is not limited to more details of the system of means, methods, apparatus and procedures contained in facet 030807 in FIG. 2. This figure represents the returning aggregations, represented by Facet 911, Facet 931, Facet 921 and Facet 941; with a completed first-phase transaction in the marketplace.

Facet 911 is a completed first-phase transaction of the aggregation represented by Facet 91 in FIG. 8A. This facet contains components with completed first-phase transactions represented by Facet 451, Facet 551, Facet 231, Facet 251 and Facet 351. These facets correspond respectively to the components in aggregation 91 shown in FIG. 8A.

Facet 931 is a completed first-phase transaction of the aggregation represented by Facet 93 in FIG. 8A. This facet contains components with completed first-phase transactions represented by Facet 431, Facet 531, Facet 131, Facet 331 and Facet 371. These facets correspond respectively to the components in aggregation 93 shown in FIG. 8A.

Facet 921 is a completed first-phase transaction of the aggregation represented by Facet 92 in FIG. 8B. This facet contains components with completed first-phase transactions represented by Facet 571, Facet 121, Facet 221, Facet 241 and Facet 261. These facets correspond respectively to the components in aggregation 92 shown in FIG. 8B.

Facet 941 is a completed first-phase transaction of the aggregation represented by Facet 94 in FIG. 8B. This facet contains components with completed first-phase transactions represented by Facet 421, Facet 441, Facet 461; Facet 521, Facet 541, Facet 561, Facet 581; Facet 141, Facet 151, Facet 161; and Facet 321, Facet 341, Facet 361, Facet 381. These facets correspond respectively to the components in aggregation 94 shown in FIG. 8B.

FIG. 10

This figure includes but is not limited to more details of the system of means, methods, apparatus and procedures contained in facet 030807 in FIG. 2.

The aggregations are disaggregated into their components. The components are re-aggregated as the ‘aggregated’ assignments, projects, contracts, purchase-orders etc., that correspond to Facet 81 in FIG. 6.

Facet 811 is the aggregation of Facet 611 and Facet 711.

Facet 611 is the aggregation of Facet 111, Facet 211 and Facet 311.

Facet 711 is the aggregation of Facet 411 and Facet 511.

Facet 111 is the completed first-phase transaction of the assignment, project, contract, purchase-order etc., represented by Facet 11 in FIG. 6. This facet contains components with the completed first-phase transaction of the assignment, project, purchase-order represented by Facet 121, Facet 131, Facet 141, Facet 151 and Facet 161.

Facet 211 is the completed first-phase transaction of the assignment, project, contract, purchase-order etc., represented by Facet 21 in FIG. 6. This facet contains components with the completed first-phase transaction of the assignment, project, contract, purchase-order etc., represented by Facet 221, Facet 231, Facet 241, Facet 251 and Facet 261.

Facet 311 is the completed first-phase transaction of the assignment, project, contract, purchase-order etc., represented by Facet 31 in FIG. 6. This facet contains components with the completed first-phase transaction of the assignment, project, contract, purchase-order etc., represented by Facet 321, Facet 331, Facet 341, Facet 351, Facet 361, Facet 371 and Facet 381.

Facet 411 is the completed first-phase transaction of the assignment, project, contract, purchase-order etc., represented by Facet 41 in FIG. 6. This facet contains components with the completed first-phase transaction of the assignment, project, contract, purchase-order etc., represented by Facet 421, Facet 431, Facet 441, Facet 451 and Facet 461.

Facet 511 is the completed first-phase transaction of the assignment, project, contract, purchase-order etc., represented by Facet 51 in FIG. 6. This facet contains components with the completed first-phase transaction of the assignment, project, contract, purchase-order etc., represented by Facet 521, Facet 531, Facet 541, Facet 551, Facet 561, Facet 571 and Facet 581.

FIG. 11A

This figure includes but is not limited to more details of the system of means, methods, apparatus and procedures contained in facet 030807 in FIG. 2.

This figure represents the completed first-phase transactions of the three beginning or original assignment/s, project/s, contract/s purchase-order/s etc., separated from the two piggy-backed assignment/s, project/s, contract/s, purchase-order/s etc.

Facet 611 is the collective of the completed first-phase transaction of the assignment, project, contract, purchase-order etc., represented by facet 61 in FIG. 5A. This Facet 611 is shown to be of a different size than the Facet 61 representing a change during the transaction.

Facet 111 is the completed first-phase transaction of the assignment, project, contract, purchase-order etc., represented by Facet 11 in FIG. 5A. This facet contains components with the completed first-phase transaction of the assignment, project, contract, purchase-order etc., represented by Facet 121, Facet 131, Facet 141, Facet 151 and Facet 161.

Facet 211 is the completed first-phase transaction of the assignment, project, contract, purchase-order etc., represented by Facet 21 in FIG. 5A. This facet contains components with the completed first-phase transaction of the assignment, project, contract, purchase-order etc., represented by Facet 221, Facet 231, Facet 241, Facet 251 and Facet 261.

Facet 311 is the completed first-phase transaction of the assignment, project, contract, purchase-order etc., represented by Facet 31 in FIG. 5A. This facet contains components with the completed first-phase transaction of the assignment, project, contract, purchase-order etc., represented by Facet 321, Facet 331, Facet 341, Facet 351, Facet 361, Facet 371 and Facet 381.

FIG. 11B

This figure includes but is not limited to more details of the system of means, methods, apparatus and procedures contained in facet 030807 in FIG. 2.

This figure represents the completed first-phase transactions of the two piggy-backed assignment/s, project/s, contract/s, purchase-order/s etc.

Facet 711 is the collective of the completed first-phase transaction of the assignment, project, contract, purchase-order etc., represented by facet 71 in FIG. 5B. This Facet 711 is shown to be of a different size than the Facet 71 representing a change during the transaction.

Facet 411 is the completed first-phase transaction of the assignment, project, contract, purchase-order etc., represented by Facet 41 in FIG. 5B. This facet contains components with the completed first-phase transaction of the assignment, project, contract, purchase-order etc., represented by Facet 421, Facet 431, Facet 441, Facet 451 and Facet 461.

Facet 511 is the completed first-phase transaction of the assignment, project, contract, purchase-order etc., represented by Facet 51 in FIG. 5B. This facet contains components with the completed first-phase transaction of the assignment, project, contract, purchase-order etc., represented by Facet 521, Facet 531, Facet 541, Facet 551, Facet 561, Facet 571 and Facet 581.

FIG. 12A

This figure includes but is not limited to more details of the system of means, methods apparatus and procedures contained in facet 030807 in FIG. 2. This figure represents the separation of the beginning or original assignments, projects, contracts, purchase-orders etc., from the collective represented by facet 611 in FIG. 11A.

Facet 111 is the completed first-phase transaction of the assignment, project, contract, purchase-order etc., represented by Facet 11 in FIG. 4A. This facet contains components with the completed first-phase transaction of the assignment, project, contract, purchase-order etc., represented by Facet 121, Facet 131, Facet 141, Facet 151 and Facet 161.

Facet 211 is the completed first-phase transaction of the assignment, project, contract, purchase-order etc., represented by Facet 21 in FIG. 4A. This facet contains components with the completed first-phase transaction of the assignment, project, contract, purchase-order etc., represented by Facet 221, Facet 231, Facet 241, Facet 251 and Facet 261.

Facet 311 is the completed first-phase transaction of the assignment, project, contract, purchase-order etc., represented by Facet 31 in FIG. 4A. This facet contains components with the completed first-phase transaction of the assignment, project, contract, purchase-order etc., represented by Facet 321, Facet 331, Facet 341, Facet 351, Facet 361, Facet 371 and Facet 381.

FIG. 12B

This figure includes but is not limited to more details of the system of means, methods, apparatus and procedures contained in facet 030807 in FIG. 2.

This figure represents the separation of the piggy-backed assignments, projects, contracts, purchase-orders etc., from the collective represented by facet 711 in FIG. 11B.

Facet 411 is the completed first-phase transaction of the assignment, project, contract, purchase-order etc., represented by Facet 41 in FIG. 4B. This facet contains components with the completed first-phase transaction of the assignment, project, contract, purchase-order etc., represented by Facet 421, Facet 431, Facet 441, Facet 451 and Facet 461.

Facet 511 is the completed first-phase transaction of the assignment, project, contract, purchase-order etc., represented by Facet 51 in FIG. 4B. This facet contains components with the completed first-phase transaction of the assignment, project, contract, purchase-order etc., represented by Facet 521, Facet 531, Facet 541, Facet 551, Facet 561, Facet 571 and Facet 581.

FIG. 13A

This figure includes but is not limited to more details of the system of means, methods apparatus and procedures contained in facet 030807 in FIG. 2.

Facet 111 represents the completed first-phase transaction of the assignment, project, contract, purchase-order etc., with restored identities of the components prior to analysis as represented by Facet 11 in FIG. 3A.

Facet 211 represents the completed first-phase transaction of the assignment, project, contract, purchase-order etc., with restored identities of the components prior to analysis as represented by Facet 21 in FIG. 3A.

Facet 311 represents the completed first-phase transaction of the assignment, project, contract, purchase-order etc., with restored identities of the components prior to analysis as represented by Facet 31 in FIG. 3A.

FIG. 13B

This figure includes but is not limited to more details of the system of means, methods apparatus and procedures contained in facet 030807 in FIG. 2.

Facet 411 represents the completed first-phase transaction of the assignment, project, contract, purchase-order etc., with restored identities of the components prior to analysis as represented by Facet 41 in FIG. 3B.

Facet 511 represents the completed first-phase transaction of the assignment, project, contract, purchase-order etc., with restored identities of the components prior to analysis as represented by Facet 51 in FIG. 3B.

### DESCRIPTION OF PREFERRED EMBODIMENTS

Assembly/ies, Sub-set of Assembly/ies and Module/s

Assembly/ies

An Assembly is a collection of components consisting of means, methods, apparatus, procedures et cetera (etc.) that can operate independently as separate components and/or as a unit; with other means, methods, apparatus, procedures etc. It is generally used in the context of functions related to business trade and commerce. Example: A ‘Resources and Resourcing’ Assembly.

Refer to FIG. 1. The present invention utilizes a procurement system that uses a number of Assemblies such as those shown as Facet 0302 and Facet 0303. These Assemblies are set and operate within and outside an entity and/or an organization. The contents, functionality and propagation of the assemblies between hierarchal levels within the entity and/or an organization and assemblies outside the entity and/or an organization, create the customized yet flexible procurement system for a given assignment, project, purchase-order etc. Each of the Assembly is independent of its Content, Activity, and Security level. The Assemblies are integrated but can function independently.

These assemblies include but are not limited to:

Facet 0302—An Assembly consisting of the means, methods, apparatus and procedures of the function of ‘Needs Assessment’ within an organization. Such functionality is processed with an additional focus on Creation and Tracking of Capital. This facet also represents its two-directional communication and exchange of data and information with other facets.

Facet 0303—An Assembly consisting of the means, methods, apparatus and procedures of the function of ‘Budgeting’ within an organization. Such functionality is processed with an additional focus on Creation and Tracking of Capital. This facet also represents its two-directional communication and exchange of data and information with other facets.

Facet 0307—Assembly consisting of the means, methods, apparatus and procedures of the function of ‘Resources and Resourcing’ within an organization. Such functionality is processed with an additional focus on Creation and Tracking of Capital. This facet also represents its two-directional communication and exchange of data and information with other facets.

Facet 0308—Assembly consisting of the means, methods, apparatus and procedures of the function of ‘Procurement’ within an organization. Such functionality is processed with an additional focus on Creation and Tracking of Capital. This facet also represents its two-directional communication and exchange of data and information with other facets.

Facet 0309—Assembly consisting of the means, methods , apparatus and procedures of the function of ‘Sales’ within an organization. Such functionality is processed with an additional focus on Creation and Tracking of Capital. This facet also represents its two-directional communication and exchange of data and information with other facets.

Facet 0310—Assembly consisting of the means, methods, apparatus and procedures of the function of ‘Contracts and Contracts Management’ within an organization. Such functionality is processed with an additional focus on Creation and Tracking of Capital. This facet also represents its two-directional communication and exchange of data and information with other facets.

Facet 0316—Assembly consisting of the means, methods, apparatus and procedures of the function of ‘Markets and Market Conditions’ within an organization. Such functionality is processed with an additional focus on Creation and Tracking of Capital. This facet also represents its two-directional communication and exchange of data and information with other facets.

Facet 0317—Assembly consisting of the means, methods, apparatus and procedures of the function of ‘Analytics and Reporting’ within an organization. Such functionality is processed with an additional focus on Creation and Tracking of Capital. This facet also represents its two-directional communication and exchange of data and information with other facets.

Facet 0502—Assembly consisting of the means, methods, apparatus and procedures of the Network Set-up functions of an organization. This assembly communicates and exchanges data and information with all other assemblies at this level as well as other assemblies at other levels.

Facet 0601—Assembly consisting of the means, methods, apparatus and procedures of the Network Administration function of an organization. This assembly consists of the means, methods, apparatus and procedures that gathers and processes data and information from different tangible and intangible sources and assemblies within an organization, as well as those outside an organization; for the administration of a value providing network of buyers and sellers of goods, works and services.

This assembly also interfaces with the means, methods, apparatus and procedures outside of this system and process and/or outside this organization for and of the participants. It makes the outside data and information usable and interactive with this system and process. It delivers this data and information to other assemblies within this system and process. It makes this system and process interact with other systems and processes outside this system and process.

This assembly has subset assemblies.

This assembly communicates and exchanges data and information with all other assemblies at this level as well as other assemblies at other levels. It communicates and exchanges data and information independently with the assemblies on level VII in the other invention. Refer to facet 0701. This facet functions as an administrator of the flow of data and information exchanging in and out of an organization.

Facet 0602—Assembly consisting of the means, methods, apparatus and procedures of the Information and Data Propagation functions of an organization. This assembly consists of the means, methods, apparatus and procedures that gathers and processes data and information from different tangible and intangible sources and assemblies within an organization, as well as those outside an organization; for the propagation of the data and information to and from other participants of a value providing network.

This assembly also interfaces with the means, methods, apparatus and procedures outside of this system and process and/or outside this organization for and of the participants. It makes the outside data and information usable and interactive with this system and process. It delivers this data and information to other assemblies within this system and process. It makes this system and process interact with other systems and processes outside this system and process.

This assembly has subset assemblies. In this configuration it represents propagating data and information upstream (to the left) to other participants. This assembly communicates and exchanges data and information with other assemblies at this level as well as other assemblies at other levels within the organization and with assemblies outside the organization. This assembly provides the means, methods, apparatus, procedures etc. to propagate data and information.

Facet 0603—Assembly consisting of the means, methods, apparatus and procedures of the Information and Data Propagation functions of an organization. This assembly consists of the means, methods, apparatus and procedures that gathers and processes data and information from different tangible and intangible sources and assemblies within an organization, as well as those outside an organization; for the propagation of the data and information to and from other participants of a value providing network.

This assembly also interfaces with the means, methods, apparatus and procedures outside of this system and process and/or outside this organization for and of the participants. It makes the outside data and information usable and interactive with this system and process. It delivers this data and information to other assemblies within this system and process. It makes this system and process interact with other systems and processes outside this system and process.

This assembly has subset assemblies. In this configuration it represents propagating data and information downstream (to the right in the figure) to other participants. This assembly communicates and exchanges data and information with all other assemblies at this level as well as other assemblies at other levels within the organization and with assemblies outside the organization. This assembly provides the means, methods, apparatus, procedures etc. to propagate data and information.

Facet 0604—Assembly consisting of the means, methods, apparatus and procedures of the Facilitation functions of an organization. This assembly consists of the means, methods, apparatus and procedures that gathers and processes data and information from different tangible and intangible sources and assemblies within an organization, as well as those outside an organization; for the facilitation of the data and information to and from other participants of a value providing network.

This assembly also interfaces with the means, methods, apparatus and procedures outside of this system and process and/or outside this organization for and of the participants. It makes the outside data and information usable and interactive with this system and process. It delivers this data and information to other assemblies within this system and process. It makes this system and process interact with other systems and processes outside this system and process.

This assembly has subset assemblies. In this configuration it represents facilitating data and information upstream (to the left in the figure) to other participants. This assembly communicates and exchanges data and information with all other assemblies at this level as well as other assemblies at other levels within the organization and with assemblies outside the organization. This assembly provides the means, methods, apparatus procedures etc. to facilitate data and information.

Facet 0605—Assembly consisting of the means, methods, apparatus and procedures of the Facilitation functions of an organization. This assembly consists of the means, methods, apparatus and procedures that gathers and processes data and information from different tangible and intangible sources and assemblies within an organization, as well as those outside an organization; for the facilitation of the data and information to and from other participants of a value providing network.

This assembly also interfaces with the means, methods, apparatus and procedures outside of this system and process and/or outside this organization for and of the participants. It makes the outside data and information usable and interactive with this system and process. It delivers this data and information to other assemblies within this system and process. It makes this system and process interact with other systems and processes outside this system and process.

This assembly has subset assemblies. In this configuration it represents facilitating data and information downstream (to the right) to other participants. This assembly communicates and exchanges data and information with all other assemblies at this level as well as other assemblies at other levels within the organization and with assemblies outside the organization. This assembly provides the means, methods, apparatus procedures etc. to facilitate data and information.

Facet 0701—Assembly consisting of the means, methods, apparatus and procedures of the Oversight functions of an organization. This assembly consists of the means, methods, apparatus and procedures that gathers and processes data and information from different tangible and intangible sources and assemblies within an organization, as well as those outside an organization; for the functions that include but not limited to oversight, audits, supervision of the functioning of this system and process of the organization, or those participating as participants of a value providing network.

This assembly also interfaces with the means, methods, apparatus and procedures outside of this system and process and/or outside this organization for and of the participants. It makes the outside data and information usable and interactive with this system and process. It delivers this data and information to other assemblies within this system and process. It makes this system and process interact with other systems and processes outside this system and process.

This assembly has subset assemblies. This assembly communicates and exchanges data and information with all other assemblies at this level as well as other assemblies at other levels.

The functionality of this assembly is unique. Modules within this assembly have special secure features both in access to them and in their functioning. Modules allow for ‘overseeing’ all other activities at all levels within this system and to those that it is connected external to its immediate system. The assembly can provide ‘audit trails’ both archived and in real time.

The assembly is flexible such that it may or may not be connected to any other part of internal or external systems without affecting their usage or performance.

Sub-set of Assembly/ies

A sub-set of an Assembly is a component of the Assembly. It operates in subordination to its Assembly.

Refer to FIG. 2. The procurement system of the present invention uses a number of sub-set of Assemblies such as the sub-set Assembly represented by Facet 030802.

These sub-sets of Assemblies are set and operate within the Assembly. The contents, functionality and propagation of these sub-sets create the customized yet flexible Assembly.

Each of the sub-set of an Assembly is independent of its Content, Activity, and Security level. The sub-sets of Assemblies are integrated but can function independently (such as a module), or in combination with other Assemblies or sub-set of Assemblies.

The sub-set of Assemblies includes but is not limited to:

Facet 030701—Sub-set of Assembly described as Facet 0307. The subject matter consists of a system of means, methods, apparatus and procedures for coding for goods, works and services.

Facet 030702—Sub-set of Assembly described as Facet 0307. The subject matter consists of a system of means, methods, apparatus and procedures of targeted-resourcing.

Facet 030703—Sub-set of Assembly described as Facet 0307. The subject matter consists of a system of means, methods, apparatus and procedures of evaluation of resources.

Facet 030801—Sub-set of Assembly described as Facet 0308. The subject matter consists of a system of means, methods, apparatus and procedures of an upstream-tier-system.

Facet 030802—Sub-set of Assembly described as Facet 0308. The subject matter consists of a system of means, methods, apparatus and procedures of central dispensation of multiple procurement and/or sales techniques.

Facet 030803—Sub-set of Assembly described as Facet 0308. The subject matter consists of a system of means, methods, apparatus and procedures of specifications and specifying good/s, work/s, commodity/ies and/or service/s.

Facet 030804—Sub-set of Assembly described as Facet 0308. The subject matter consists of a system of means, methods, apparatus and procedures of virtual pricing.

Facet 030805—Sub-set of Assembly described as Facet 0308. The subject matter consists of a system of means, methods, apparatus and procedures of trading baskets for procurement.

Facet 030806—Sub-set of Assembly described as Facet 0308. The subject matter consists of a system of means, methods, apparatus and procedures of pricing.

Facet 030807—Sub-set of Assembly described as Facet 0308. This sub-set of the Assembly also functions as the procurement system module. The facet consists of a system of means, methods and procedures of optimized central procurement. It provides the means, methods, apparatus procedures etc. to facilitate data and information described by, but not limited to: FIG. 3A, FIG. 3B, FIG. 4A, FIG. 4B, FIG. 5A, FIG. 5B, FIG. 6, FIG. 7A, FIG. 7B, FIG. 7C, FIG. 7D, FIG. 8A, FIG. 8B, FIG. 9, FIG. 10, FIG. 11A, FIG. 11B, FIG. 12A, FIG. 12B, FIG. 13A and FIG. 13B.

Facet 030901—Sub-set of Assembly described as Facet 0309. The subject matter consists of a system of means, methods, apparatus and procedures of a downstream-tier-system.

Facet 030902—Sub-set of Assembly described as Facet 0309. The subject matter consists of a system of means, methods, apparatus and procedures of trading baskets for sales.

Facet 031001—Sub-set of Assembly described as Facet 0310. The subject matter consists of a system of means, methods, apparatus and procedures of contract evaluation.

Facet 031002—Sub-set of Assembly described as Facet 0310. The subject matter consists of a system of means, methods, apparatus and procedures of contract preparation.

Module

A Module is an independent unit within an ‘Assembly’. It is a collection of components consisting of means, methods, apparatus, procedures etc. These components implement specific functions that are used to conduct trade commerce and business.

An Assembly may have one or more Modules.

The modules contain additional granularity in groups of elements arranged by smaller collections of sub-sets of Assemblies, jobs, apparatus, items etc.

A module includes but is not limited to:

The procurement system module is a part of this invention. It is described as Facet 030807 in FIG. 2 and further described in FIG. 3A, FIG. 3B, FIG. 4A, FIG. 4B, FIG. 5A, FIG. 5B, FIG. 6, FIG. 7A, FIG. 7B, FIG. 7C, FIG. 7D, FIG. 8A, FIG. 8B. FIG. 9, FIG. 10, FIG. 11A, FIG. 11B, FIG. 12A, FIG. 12B, FIG. 13A and FIG. 13B. The means, methods, apparatus and procedures described in these figures are further integrated with the means, methods, apparatus and procedures described in FIG. 1.

Procurement System of the Present Invention

The procurement system of the present invention is a system and process. This system and process is made up of a cluster of integrated and interacting Assemblies, sub-set of Assemblies and Modules; functioning individually or in combination. It is an interactively functioning collection of means, methods, apparatus and procedures which are implemented manually and/or automated electronically.

The procurement system module of the present invention is a sub-set of Assembly described as Facet 0308. This module is referred as Facet 030807 in FIG. 2. This module consists of a system and process of means, methods, apparatus and procedures for central-procurement that are optimized. It provides the means, methods, apparatus and procedures to conduct business, trade and commerce and to facilitate data and information described by, but not limited to: FIG. 3A, FIG. 3B, FIG. 4A, FIG. 4B, FIG. 5A, FIG. 5B, FIG. 6, FIG. 7A, FIG. 7B, FIG. 7C, FIG. 7D, FIG. 8A, FIG. 8B, FIG. 9, FIG. 10, FIG. 11A, FIG. 11B, FIG. 12A, FIG. 12B, FIG. 13A and FIG. 13B. The means, methods, apparatus and procedures described in these figures are further integrated with the means, methods, apparatus and procedures described in FIG. 1.

The procurement system of the present invention may be used in conjunction with or independent of a value providing network. It is of use to entities, individuals, organizations or selective units within an organization participating in business trade and commerce as an individual or a team. It provides mutual benefit and enhancement of value for the users on single or multiple assignments, project/s, purchase-order/s etc. The procurement system of the present invention is applicable to goods, services, public works and commodities in conducting trade and commerce in all markets within the private and public sectors.

The users may also be intermediaries or representatives of buyer/s. It is also available for use by the participants or intermediaries who participate in a value providing network as a participant, a Network Manager or a Network Administrator. Multiple users working on multiple assignment/s, project/s, contract/s, purchase-order/s etc., may concurrently use the procurement system of the present invention

Operations

A sequence of operation is described to illustrate the process. The illustrations are drawn generally in sequence and represented by FIG. 3A, FIG. 3B, FIG. 4A, FIG. 4B, FIG. 5A, FIG. 5B, FIG. 6, FIG. 7A, FIG. 7B, FIG. 7C, FIG. 7D, FIG. 8A, FIG. 8B, FIG. 9, FIG. 10, FIG. 11A, FIG. 11B, FIG. 12A, FIG. 12B, FIG. 13A,and FIG. 13B. The operations are furthermore integrated with and include the means, methods, apparatus and procedures described in FIG. 1 and FIG. 2.

Other sequences and/or size of operations may be undertaken based on a given original and/or piggy-backed assignment/s, project/s, purchase-order/s, requisition/s, contract/s etc.

Set-up of Assignment/s, Project/s, Purchase-Order/s, Requisition/s, Contract/s, etc.

An assignment/s, project/s, purchase-order/s, contract/s, requisition etc. is set-up using the assembly represented by facet 0302—Needs Assessment and the assembly represented by facet 0303—Budgeting, shown in FIG. 1.

These assignment/s, project/s, purchase-order/s, contract/s, requisition etc. are formatted by using the sub-set assembly represented by facet 030803—Specifications, shown in FIG. 2.

These formatted assignment/s, project/s, purchase-order/s, contract/s, requisition etc. are shown in FIG. 3A and FIG. 3B.

Analysis of Assignment/s, Project/s, Purchase-Order/s, Requisition/s, Contract/s, etc.

Refer to FIG. 4A. The analysis for each assignment/s, project/s, purchase-order/s, contract/s, requisition/s etc. includes but is not limited to:

a) Identify the Components that have a Value-added or No-Value-added in the delivery from the source to the end-user and/or

b) Identify the Components that are unique to the creation of goods, works, commodities or services at certain tiers and/or

c) Identify the Components that are unique to the creation of goods, works, commodities or services related to specific market sectors and/or

d) Identify the candidacy for Aggregation of Assignments

Such analysis establishes the components of the assignment/s, project/s, purchase-order/s, contract/s etc. The components are represented by slices of the whole box (assignment/s, project/s etc.):

Facet 11—whole box, which contains components represented by slices—Facet 12, Facet 13, Facet 14, Facet 15 and Facet 16.

Facet 21—whole box, which contains components represented by slices—Facet 22, Facet 23, Facet 24, Facet 25 and Facet 26.

Facet 31—whole box, which contains components represented by slices—Facet 32, Facet 33, Facet 34, Facet 35, Facet 36, Facet 37 and Facet 38.

Analysis of Piggy-backed Assignment/s, Project/s, Purchase-Order/s, Requisition/s, Contract/s, etc.

Refer to FIG. 4B. The analysis for each additional, diverse and non-related assignment/s, project/s, contract/s, purchase-order/s etc.; for piggy-backing on the beginning or original assignment/s, project/s, contract/s, purchase-order/s, requisition/s etc., includes but is not limited to:

a) Identify the Components that have a Value-added or No-Value-added in the delivery from the source to the end-user and/or p0 b) Identify the Components that are unique to the creation of goods, works, commodities or services at certain tiers and/or

c) Identify the Components that are unique to the creation of goods, works, commodities or services related to specific market sectors and/or

d) Identify the candidacy for Aggregation of piggy-backed Assignments

Such analysis establishes the components of the assignment/s, project/s, purchase-order/s, contract/s, requisition/s etc. The components are represented by slices of the whole box (assignment/s, project/s etc.):

Facet 41—whole box, which contains components represented by slices—Facet 42, Facet 43, Facet 44, Facet 45 and Facet 46.

Facet 51—whole box, which contains components represented by slices—Facet 52, Facet 53, Facet 54, Facet 55, Facet 56, Facet 57 and Facet 58.

Identification and Coding of Assignment/s, Project/s, Purchase-Order/s, Requisition/s, Contract/s etc.

Refer to FIG. 4A. Each component is coded which includes but is not limited to:

1. Unique originating assignment, project, purchase-order or requisition

2. Value-added or Non-Value-added characteristics

3. Tier

4. Market sector

5. Other Proprietary or Non-proprietary Classification coding systems

The coding is represented by single-hatch, double-hatch, polka-dot or blank markings on the components which are represented by slices—Facet 12, Facet 13, Facet 14, Facet 15 and Facet 16; Facet 22, Facet 23, Facet 24, Facet 25 and Facet 26; Facet 32, Facet 33, Facet 34, Facet 35, Facet 36, Facet 37 and Facet 38.

Identification and Coding of Piggy-backed Assignment/s, Project/s, Purchase-Order/s, Requisition/s, Contract/s, etc.

Refer to FIG. 4B. Each component is coded which includes but is not limited to:

1. Unique originating assignment

2. Value-added or Non-Value-added characteristics

3. Tier

4. Market sector

5. Other Proprietary or Non-proprietary Classification coding systems

The coding is represented by single-hatch, double-hatch, polka-dot or blank markings on the components which are represented by slices—Facet 42, Facet 43, Facet 44, Facet 45 and Facet 46; Facet 52, Facet 53, Facet 54, Facet 55, Facet 56, Facet 57 and Facet 58.

Aggregation of Assignment/s, Project/s, Purchase-Order/s, Requisition/s, Contract/s, etc.

Refer to FIG. 5A. Individual assignment/s, project/s, purchase-order/s, contract/s, requisition etc. are aggregated to create a combined unit, represented by Facet 61.

Aggregation of Piggy-backed Assignment/s, Project/s, Purchase-Order/s, Requisition/s, Contract/s, etc.

Refer to FIG. 5B. Individual piggy-backed assignment/s, project/s, purchase-order/s, contract/s, requisition etc. are aggregated to create a combined unit, represented by Facet 71.

Aggregation of Assignment/s, Project/s, Purchase-Order/s, Requisition/s, Contract/s, etc. and Piggy-backed Assignment/s, Project/s, Purchase-Order/s, Requisition/s, Contract/s, etc.

Refer to FIG. 6. All of the beginning or original assignment/s, project/s, purchase-order/s, contract/s, requisition/s etc. and piggy-backed assignment/s, project/s, purchase-order/s, contract/s, requisition/s etc. are aggregated as shown in Facet 81. All identification and coding for each of the individual components is maintained.

Disaggregation of Assignment/s, Project/s, Purchase-Order/s, Requisition/s, Contract/s, etc. into Separate Baskets

Refer to FIG. 7A. The uniquely identified and coded components that are similar are disaggregated from the earlier aggregation of the assignment/s, project/s. purchase-order/s, contract/s, requisition/s etc. and/or piggy-backed assignment/s, project/s. purchase-order/s, contract/s, requisition/s etc. into a separate and unique group or basket. This basket is given a new identity.

Refer to FIG. 7B. The uniquely identified and coded components that are similar are disaggregated from the earlier aggregation of the assignment/s, project/s. purchase-order/s, contract/s, requisition/s etc. and/or piggy-backed assignment/s, project/s. purchase-order/s, contract/s, requisition/s etc. into a separate and unique group or basket. This basket is given a new identity.

Refer to FIG. 7C. The uniquely identified and coded components that are similar are disaggregated from the earlier aggregation of the assignment/s, project/s. purchase-order/s, contract/s, requisition/s etc. and/or piggy-backed assignment/s, project/s. purchase-order/s, contract/s, requisition/s etc. into a separate and unique group or basket. This basket is given a new identity.

Refer to FIG. 7D. The remaining identified and coded components are disaggregated from the earlier aggregation of the assignment/s, project/s. purchase-order/s, contract/s, requisition/s etc. and/or piggy-backed assignment/s, project/s. purchase-order/s contract/s, etc. into a separate and unique group or basket. This basket is given a new identity.

Procurement and Trade Methods for Baskets

Refer to FIG. 2 facet 030802—Procurement and Trade Methods. Also refer FIG. 1 Facet 0316—Markets and Market Conditions. Also refer to FIG. 8A facets 01 and 05, and FIG. 8B facets 03 and 07.

Each basket is analyzed for the optimum procurement and trade method based on the given market/s and market conditions at a given time. The basket is modified to accept transactions based on the selected procurement and trade method.

Resourcing for Baskets

Refer to FIG. 2, facet 030702—Targeted Resourcing. Also refer FIG. 8A facets 02 and 06, and FIG. 8B facets 04 and 08.

The baskets are resourced for a targeted market to obtain the best match for the pre-set criteria most appropriate to individual basket. The buyer has the option to market the baskets such that the seller may or may not recognize the beginning, original or piggy-backed assignment/s, project/s, contract/s, purchase-order/s in the original format. Refer to FIG. 1. The baskets are propagated and facilitated to the resources by using the Assemblies represented by Facet 0601, Facet 0602, Facet 0603, Facet 0604, Facet 0605 and Facet 0606

Transaction of Baskets

Refer to FIG. 8A and FIG. 8B. The first phase of the transaction is conducted between the buyer and seller on the basket. This phase includes but is not limited to:

Two-way communication consisting of connecting a buyer and a potential seller.

Sharing the contract documents

Sharing the qualifying documents

Submitting and receiving of quote, bid, tender, proposal, offer etc. and/or the associated terms and conditions between the buyer and the seller.

Negotiations between the buyer and seller if required, necessary or called for.

The baskets with completed first-phase transactions are returned as shown in FIG. 9 facet 911, facet 931, facet 921 and facet 941.

Disaggregate Baskets and

Re-aggregate into Original Assignment/s, Project/s, Purchase-Order/s, Requisition/s, Contract/s, etc. and piggy-backed Assignment/s, Project/s, Purchase-Order/s, Requisition/s, Contract/s, etc.

Refer to the sequence of FIG. 10, FIG. 11A, FIG. 11B, FIG. 12A, and FIG. 12B. Upon completion of the transaction/s, disaggregate the baskets into individual components with all of the data and information attached to it as the events transpired.

Refer to FIG. 13A and FIG. 13B. Re-aggregate the components back to the original assignment/s, project/s. purchase-order/s, requisition/s, contract/s etc. and the piggy-backed assignment/s, project/s. purchase-order/s, requisition/s, contract/s etc. Deliver the original assignment/s, project/s. purchase-order/s, requisition/s, contract/s etc. and the piggy-backed assignment/s, project/s. purchase-order/s, requisition/s, contract/s etc. to the appropriate buyer/s. The details of the transactions are submitted to the Facet 0317 in FIG. 1.

Alternate Options for the Sequence of Operations for the Original Assignment/s, Project/s, Purchase-Order/s, Requisition/s, Contract/s, etc. and piggy-backed Assignment/s, Project/s, Purchase-Order/s, Requisition/s, Contract/s, etc.

The sequence of operations described thus far is a detailed route that an individual assignment/s, project/s, purchase-order/s, requisition/s, contract/s etc. may take. Other options may be implemented that use only selected parts of the operations described thus far. Or an option may use combinations of certain operations only. Such options include but are not limited to:

The original assignment/s, project/s, purchase-order/s, requisition/s, contract/s etc. may be retained as whole and not further analyzed or coded for specific components as shown FIG. 4A. They may be retained as shown in facet 11, facet 21, and facet 31 in FIG. 3A. These facets follow through with the sequence of operation as shown in facet 61 in FIG. 5A and as a part of facet 81 in FIG. 6 (should piggy-backed assignment/s, project/s, purchase-order/s be available or desired).

The piggy-backed assignment/s, project/s, purchase-order/s, requisition/s, contract/s etc. may be retained as whole and not further analyzed or coded for specific components as shown FIG. 4B. They may be retained as shown in facet 41, and facet 51 in FIG. 3B. These facets follow through with the sequence of operation as shown in facet 71 in FIG. 5B and as a part of facet 81 in FIG. 6.

Baskets may consist of the individual and original assignment/s, project/s, purchase-order/s, requisition/s, contract/s etc. represented by facet 11, facet 21 and facet 31 or if desired facet 61 as an aggregation. Such baskets may follow the sequence of operations described above that includes but is not limited to implementing:

Procurement and Trade Methods

Resourcing

Transaction

Baskets may consist of the individual and original assignment/s, project/s, purchase-order/s, requisition/s, contract/s etc. represented by facet 41, and facet 51 or if desired facet 71 as an aggregation. Such baskets may follow the sequence of operations described above that includes but is not limited to implementing:

Procurement and Trade Methods

Resourcing

Transaction

Any aggregation such as facet 61-FIG. 5A, facet 71-figure 5B or facet 81-FIG. 6; when treated as baskets is disaggregated after the completion of the first-phase transaction; back to its individual assignment/s, project/s, purchase-order/s, requisition/s, contract/s etc.

The sequence of operations continues as with any other original or piggy-backed assignment/s, project/s, purchase-order/s, requisition/s, contract/s etc.

Analytics and Reporting

The details of the transactions are submitted for analysis and reporting to the assembly represented by Facet 0317 in FIG. 1. Details include but are not limited to:

1. Original budget set for the assignment/s, project/s, purchase-order/s, requisition, contract/s etc.

2. Specifications for the assignment/s, project/s, purchase-order/s, requisition, contract/s etc.

3. Participants resourced and invited

4. Participants who requested the contract documents required to respond

5. Participants who responded to the invitations

6. Analysis of the responders

7. Response of the responders in narrative and numbers

Complete Individual Transaction of Each Original Assignment/s, Project/s, Purchase-Order/s, Requisition/s, Contract/s, etc. and Piggy-Backed Assignment/s, Project/s, Purchase-Order/s, Requisition/s, Contract/s, etc.

Complete remaining transaction for the original Assignment/s, Project/s, Purchase-Order/s, contract/s etc. and the Piggy-backed Assignment/s, Project/s, Purchase-Order/s, contract/s etc. as it relates to other Assemblies such as those noted in FIG. 2 facet 031001 Contract Evaluation and FIG. 2 facet 031002 Contract Preparation etc. Such transactions may include but not limited to:

1. Evaluation details and/or summary

2. Acceptance documents

3. Approved Purchase Order

4. Agreement and/or Contract Documents

Oversight

Refer to Facet 0701 in FIG. 1. The details of the operations are independently transmitted and archived at each step through the entire sequence of operations. Such details may be retrieved and/or analyzed by participants and/or independent entitiy/ies with appropriate access to such details.

Concurrent Operations

The figures and operations illustrate the principles of this invention. The invention is capable of concurrently conducting multiple operations for a given user. Furthermore, at any given time, multiple users may conduct multiple operations concurrently.

Use and Management of One or Multiple Elements Concurrently

Refer to FIG. 3A. The invention is capable of concurrently setting-up, using and managing one and/or multiple beginning or original assignment/s, project/s, purchase-order/s, requisition/s, contract/s etc.

Refer to FIG. 3B. The invention is capable of concurrently setting-up, using and managing one and/or multiple piggy-backed assignment/s, project/s, purchase-order/s, requisition/s, contract/s etc.

Refer to FIG. 4A. The invention is capable of concurrently analyzing, identifying, and coding one and/or multiple beginning or original assignment/s, project/s, purchase-order/s, requisition/s, contract/s etc.

Refer to FIG. 4B. The invention is capable of concurrently analyzing, identifying, and coding one and/or multiple beginning or piggy-backed assignment/s, project/s, purchase-order/s, requisition/s, contract/s etc.

Refer to FIG. 5A. The invention is capable of concurrently aggregating one and/or multiple beginning or original assignment/s, project/s, purchase-order/s, requisition/s, contract/s etc.

Refer to FIG. 5B. The invention is capable of concurrently aggregating one and/or multiple piggy-backed assignment/s, project/s, purchase-order/s, requisition/s, contract/s etc.

Refer to FIG. 6. The invention is capable of concurrently aggregating one and/or multiple beginning or original and piggy-backed assignment/s, project/s, purchase-order/s, requisition/s, contract/s etc.

Refer to FIG. 7A, FIG. 7B, and FIG. 7C. The invention is capable of disaggregating one or multiple unique components from an aggregation of original and/or piggy-backed assignment/s, project/s, purchase-order/s, requisition/s, contract/s etc.

The invention is capable of setting-up, using and managing multiple baskets assembled from such disaggregation

Refer to FIG. 7D. The invention is capable of disaggregating one or multiple non-unique and/or remaining components from an aggregation of original and/or piggy-backed assignment/s, project/s, purchase-order/s, requisition/s, contract/s etc. The invention is capable of setting-up, using and managing multiple baskets assembled from such disaggregation.

Refer to FIG. 8A and FIG. 8B. The invention is capable of setting up, managing and conducting one or multiple transactions using concurrent targeted resourcing, multiple procurement and trading methods optimized to one or multiple baskets and in one or multiple markets.

Refer to FIG. 9. The invention is capable of managing one or multiple baskets upon completion of the one or multiple transactions shown in FIG. 8A and FIG. 8B.

Refer to FIG. 10, FIG. 11A, FIG. 11B, FIG. 12A, FIG. 12B. The invention is capable of disaggregating one or multiple baskets upon completion of the one or multiple transactions of the baskets shown in FIG. 8A and FIG. 8B.

Refer to FIG. 13A. The invention is capable of re-aggregating one or multiple original assignment/s, project/s, purchase-order/s, requisition/s, contract/s etc. from the completed one or multiple transactions of the baskets shown in FIG. 8A and FIG. 8B.

Refer to FIG. 13B. The invention is capable of re-aggregating one or multiple piggy-backed assignment/s, project/s, purchase-order/s, requisition/s, contract/s etc. from the completed one or multiple transactions of the baskets shown in FIG. 8A and FIG. 8B.

Example of an Application

This is an example of an application which shows how the invention is applied rather than a detailed example of every step in the process.

Say there are two ‘School Districts’ called District A and District B. They are a hundred miles away from each other. District A has 13 elementary schools and District B has 6 middle schools. The two school districts are completely independent regarding their funding, use of budgets etc. to operate the schools. Each district has several projects that are to be undertaken within the current fiscal year. In addition they have to manage and maintain their own facilities and run their school operations.

District A has an Administrative Officer who oversees all spending. She has set aside individual procurement budgets and a program for (a) Buildings Maintenance Operations (b) Energy (c) Construction project for a new classroom wing with 4 classrooms that will match other classrooms.

District B also has an Administrative officer who oversees all spending. He has individual procurement budgets and a program for (d) Buildings Maintenance Operations and (e) Construction Project to renovate the Athletic Field seating facilities, bathrooms and Athletic Field Lighting.

District A is using this invention. District B would like to have it but does not have the budgeted funds to have one of their own. They plan to rely on District A for whatever partial benefit they can get from the invention.

District A has followed through with this invention regarding the early phases of the procurement process and are getting ready to undertake their purchases. They setup to procure (a) (b) and (c) as separate assignments.

Just as the procurement was to have been issued, District B heard about it and requested to be piggy-backed on the District A's procurement, with their purchase of (d) and (e).

District A agrees.

The invention accepts and incorporates District B's request, on the already existing procurement of District A. The invention proceeds forward with its processes.

Upon analysis the following was identified and coded:

Assignment (a) includes Small Tools, Tires, Paint, Cleaning Supplies, Light Fixtures and Light Bulbs.

Assignment (b) includes electrical energy for one year, gasoline fuel for all school bus operations for one year and propane gas for heating all school buildings for one year.

Project (c) includes design and construction of a new classroom wing with 4 classroom wing that includes new light fixtures.

Assignment (d) includes two new welders, one new compressor, Plumbing Supplies, Light Fixtures, Light bulbs and electrical energy for one year for the whole school.

Project (e) includes design and construction of athletic field, and lighting fixtures for the athletic field.

The invention aggregates (a), (b) and (c) as orders from District A and aggregates (d) and (e) as orders from District B. The two aggregations are further aggregated as an outgoing-order. However before it goes out into the marketplace the invention disaggregates the aggregation of (a), (b), (c), (d) and (e), based on the analysis and coding; and reaggregates them as six baskets:

(1) Small Tools, Tires, Paint, Cleaning Supplies, two welders, one compressor, Plumbing Supplies.

(2) Light Fixtures and Light Bulbs.

(3) Electrical Energy

(4) Gasoline Fuel

(5) Propane Fuel

(6) Design and Construction services

These are appropriately solicited and appropriately procured based on optimum methods and conditions of the market. Upon completion of this phase of the procurement, the process continues in a reverse order to aggregate back the original and piggy-backed assignments/projects for District A and District B. This is followed with the completion of procurement details.

The above example is meant to illustrate the invention only partially. It is merely meant to illustrate an application that is using the invention, rather than limiting its scope.

Having thus described the invention, it should be apparent that numerous modifications and adaptations may be resorted to without departing from the scope and fair meaning of the instant invention as set forth hereinabove and as described hereinbelow by the claims.

I claim:

1 - A method for optimizing acquisition transactions among a plurality of projects, the steps including:
sequestering each procurement component from each said project;
pooling said procurement components from said projects into a plurality of packages, wherein each said package comprises a single procurement component, and wherein each procurement component contains a reference to its originating project;
matching each said package to a plurality of sellers;
conducting procurement transactions for said packages with said plurality of sellers according to said procurement components;
separating said packages into said procurement components, wherein said procurement components are grouped by said originating projects; and
assembling said projects from said procurement components.

2 - A network for optimizing acquisition transactions among a plurality of projects, comprising, in combination:
means for accepting a plurality of projects, each said project comprised of a plurality of procurement components;
means for sequestering each said procurement component from each said project;
means for combining said procurement components from said plurality of projects into packages, wherein each said package comprises a single procurement component, and wherein each said procurement component contains an originating project reference;
means for associating each said package with a plurality of sellers;
means for conducting procurement transactions with said plurality of sellers with respect to said packages, each said procurement transaction dependent on each said procurement component;
means for redistributing said procurement components from said packages, wherein redistribution is controlled by each said originating project reference; and
means for assembling each said project from said procurement components.

3 - A segment of a value optimization network, wherein said value optimization network optimizes value in transactions, the segment comprising, in combination:
means for accepting a plurality of projects, each said project comprised of a plurality of procurement components;
means for sequestering each said procurement component from each said project;
means for combining said procurement components from said plurality of projects into packages, wherein each said package comprises a single procurement component, and wherein each said procurement component contains an originating project reference;
means for associating each said package with a plurality of sellers;
means for conducting procurement transactions with said plurality of sellers with respect to said packages, each said procurement transaction dependent on each said procurement component;
means for redistributing said procurement components from said packages, wherein redistribution is controlled by each said originating project reference;
means for assembling each said project from said procurement components; and
means for integrating said segment with said value optimization network, wherein an integrated network derives more value.
